(19) United States
(12) Patent Application Publication
(10) Pub. No.: US 2015/0254579 A1
(43) Pub. Date: Sep. 10, 2015

(54) Smart card system for managing venue access and venue attendee rewards, and method of assembling the smart card system

(71) Applicant: Cheval Calvin Ford, San Diego, CA (US)

(72) Inventor: Cheval Calvin Ford, San Diego, CA (US)

(21) Appl. No.: 13/999,544

(22) Filed: Mar. 8, 2014

(51) Int. Cl. G06Q 10/02; G06Q 20/34

(52) U.S. Cl. CPC G06Q 10/02; G06Q 20/357

(57) ABSTRACT

Smart card system for managing venue access and venue attendee rewards, and method of assembling the smart card system. A venue access card reader is coupled to a server for reading card holder account data from a smart card and for transmitting the card holder account data read from the smart card to the server. Card holder access to a venue is granted or optionally denied while the server authenticates the card holder account data read from the smart card and returns a response signal to the venue access card reader. A rewards database is coupled to the server for granting a reward to the card holder account in real-time, so that the card holder can apply a discount in real time to purchases being made at a venue concession booth and/or subsequent purchases made at a local retail business.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISC APPENDIX

Not applicable.

### FIELD OF THE INVENTION

This invention generally relates to digital processing systems and methods, and more particularly relates to venue access systems and methods using smart cards.

### BACKGROUND OF THE INVENTION

Access control systems are often used to control access to venues, such as sports stadiums, concert halls, theaters, amusement parks, universities, colleges, high schools, and other venues. Events, such as sport contests, concerts, movies, theme park attractions, and other events occur at these venues. Typically, controlled access to such events is restricted to paying customers who pay with cash, conventional debit cards and credit cards.

However, traditional payment means, such as cash, conventional debit cards and credit cards have proven problematic when used to gain access to crowded event venues, such as sports stadiums, concert halls, theaters, amusement parks, universities, colleges, high schools, and other event venues. In this regard, a venue attendee paying with cash or by means of a debit card or credit card may have to wait in a long queue that leads to a ticket booth. A ticket booth attendant at the ticket booth processes the attendee's cash, debit card or credit card transaction. Also, in some cases, when the venue attendee uses a debit card or credit card, the venue attendee is required to sign a print-out provided by the ticket booth attendant in order to document and verify the transaction in an accounting system. Time taken to print and sign the print-out extends the venue admission process. Thus, use of cash, a debit card or a credit card can substantially lengthen the time for the venue attendee to approach the ticket booth and complete the payment transaction. After payment, the venue attendee is typically issued a paper admission ticket. The paper admission ticket is then presented to a ticket taker, who accepts the paper admission ticket in order to finally allow the venue attendee into the venue. However, the lengthy time taken to process the payment transaction and accept the paper admission ticket can lead to a slow-moving queue that inconveniences the venue attendee. Therefore, a consideration in the art is the inconvenience caused a venue attendee due to the lengthy time taken to purchase an admission ticket from the venue ticket booth attendant and then present the admission ticket to the venue ticket taker for admission into the venue.

In addition, need for a ticket booth attendant and ticket taker increases labor costs associated with the event. Therefore, an additional consideration in the art is increased labor costs due to the need for a ticket booth attendant and ticket taker.

Also, sometimes paper tickets are counterfeited and sold to unsuspecting, prospective venue attendees at the previously mentioned events. Such illegal and fraudulent sales are typically made by persons located outside, but near, the venue. The illegal and fraudulent paper tickets are offered to prospective venue attendees before the prospective venue attendees have an opportunity to approach the ticket booth to legitimately purchase tickets. These counterfeit tickets are attractive to prospective venue attendees because they are sometimes sold at a putative discount. The unsuspecting, prospective venue attendees are disappointed when the counterfeit tickets are presented to the venue ticket taker and rejected. Therefore, another consideration in the art is the sale of counterfeit paper tickets to unsuspecting, prospective venue attendees.

In addition, traditional payment means, such as cash, conventional debit cards and credit cards have proven problematic to use when rewards are offered to venue attendees. Such rewards are usually discounts, coupons and loyalty points redeemable at venue concession booths during the event and at local retail businesses subsequent to the event. As previously mentioned, the concession booths are located within the venue. The local retail businesses, such as local restaurants and retail shops, are located outside the venue. The discounts, coupons and loyalty points are offered to venue attendees in order to encourage venue attendees to patronize the concession booths during an event and to encourage venue attendees to patronize local retail businesses subsequent to the event. For example, a venue attendee may purchase items at a concession booth during the event and then patronize a local restaurant following the event. In this case, the concession booth operator might offer discounted food, discounted clothing having event insignia thereon, discounted memorabilia associated with the event, and other discounted event items. Local retail businesses might offer discounted restaurant meals, discounted apparel, and other discounted goods and services. Customarily, such rewards offered by concession booth operators and local retail businesses are sent to the venue attendee by conventional mail, electronic mail, or facsimile either before or after the venue event. Hence, there is a time-lapse between the time the reward is issued by conventional mail, electronic mail, or facsimile and the time the reward or discount can be redeemed at the venue or local retail business. Hence, traditional payment means, such as cash, conventional debit cards and credit cards, do not allow rewards to be automatically redeemable in real-time by a venue attendee as the venue attendee makes a purchase at a venue concession booth or at a local retail business following the event. Therefore, yet another consideration in the art is the inability to allow rewards to be automatically redeemable in real-time by a venue attendee while the venue attendee attends the venue (e.g., purchases made at a venue concession booth during the event), or after the event (e.g., meals purchased at a local restaurant following the event).

The amount of the reward or discount can depend on various factors. For example, the amount of the reward or discount may be proportional to the frequency at which the venue attendee has used the venue (e.g., repeated attendance at the venue). As another example, the amount of the reward or discount also may be proportional to the dollar amount of prior purchases made at the venue or at a local retail business. Other schemes for determining the amount of the reward or discount are also used.

It is instructive to define the terminologies “cash”, “debit card”, and “credit card” because the terminologies “cash”, “debit card”, and “credit card” have different meanings in the art. In this regard, the terminology “cash” is defined to mean money in the physical form of currency issued by a government authority. The terminology “debit card” is defined to mean a payment card that is associated with a specific account at a particular bank and typically has a magnetic strip thereon capable of storing specific account information and capable of providing electronic access to the bank account. When the debit card is used to purchase goods and services, the amount of the purchase is electronically deducted from the bank account. The bank account is replenished with funds provided either in person, by wire transfer, by transfer of funds between accounts at the bank, or by mail. A “credit card”, which is also commonly referred to as a “charge card”, is defined to mean a payment card having a magnetic strip thereon and that is issued to the card holder by a financial institution or retail business. The magnetic strip contains credit account information. The credit card allows the user to electronically purchase goods and services on credit and be subsequently invoiced by the financial institution or retail business.

Attempts have been made to address the considerations mentioned hereinabove. For example, U.S. Pat. No. 6,390,376 B2 titled “Method and Apparatus For Providing Targeted Advertising In Public Areas” issued May 21, 2002, in the name of Paul Bermel relates to advertising devices that provide advertising and other information targeted to the interests of persons in the vicinity of the advertising device.

According to the Bermel '376 patent, an advertising device comprises a display panel with a controller for operating the display panel. The display panel comprises an LED display mounted in a public area, such as a transit station platform. The controller communicates with an electronic, contactless smart card that contains a signal responsive electronic circuit. A reader device receives information from the card. The reader device further includes a communicator for exchanging information by a communication link with a central computer that contains a database of information such as advertisements, news, features, and other information for display by the device. The central computer also contains registration information provided by the person carrying the card. This information includes designations by the person of topical interests such as sports, news categories, and financial interests. The database maintained by the central computer provides a list of entities that offer purchase discounts to persons using the stored value cards. The information is accessible by the holder of the card through a global interactive information network, by fax on demand capability, or by conventional mail in response to a telephone, written, or electronic submission of a request for such information.

Also, according to the Bermel '376 patent, the card is presented by the owner to a provider of goods and services. The provider has a reader device for accessing the card to determine the unique codes associated with a person carrying the card. The unique codes, together with identification of the purchased goods or services are communicated to the central computer. Over time, an historical record is created by the central computer providing a historical indication of the goods and services of interest to the particular person identified by the codes. Based on the purchase history, advertisements directed to the person can be provided. This is accomplished by the controller making a general interrogation to the plurality of electronic cards within a particular range of the controller. The cards respond to the controller and provide the respective unique codes. The controller connects to the communicator for accessing the central computer. The central computer evaluates the unique codes. One or more messages of advertising are then communicated by the central computer to the communicator for transfer to the controller. The controller then sequences the received informational messages for display on the display panel. The person waiting in the public area thereby is presented with advertisements targeted to the interests of the person.

However, although the Bermel '376 patent discloses use of stored value smart cards and a database maintained by a central computer that provides a list of entities that offer purchase discounts to persons using the stored value smart cards, the person apparently must submit a request to gain access to the list in order to take advantage of the discounts. In this regard, the list apparently can be provided to the card holder through a global interactive information network, by fax on demand capability, or by conventional mail in response to a telephone, written, or electronic submission of a request for such information. The Bermel '376 patent does not appear to disclose that the discounts are provided in real-time or that the discounts are updated based on the card holder's use of the card. Also, this patent does not appear to disclose that the smart card is used to gain access to a venue.

Another attempt to address the considerations mentioned hereinabove is disclosed in U.S. Published Patent Application No. US 2011/0022655 A1 titled “Smart Card Based Fault Resistant On-Line/Off-Line Loyalty Point Accumulation System For Spectator Event Venues” published Jan. 27, 2001, in the name of Richard Daniel Pinnick, et al. This published patent application relates to venue management systems.

According to the Pinnick, et al. '655 published patent application, a venue management system provides a fault resistant online/offline loyalty benefit scheme for sports and other spectator venues based on normalized accumulated member's loyalty points stored in the member's smart card and in a venue's computer. The normalized loyalty points serve as a campaign manager's criteria for offering benefits to members during the sport venue's season. The criteria are issued to computerized points of contact subsequent to the member's gaining entrance to the venue. The first point of contact subsequent to the member's gaining entrance to the venue initializes the member's card that is operative to allow transactions with the campaign manager's criteria based venue benefit terminals. Computer controlled processes and systems facilitate loyalty purchases, coupons and information in an online and off-line mode within a venue (e.g., stadium or other such public environment). The processes and systems utilize real time data capture, benefit rules, and RFID contactless smart cards and devices. The systems can operate in both an off-line and on-line mode, based around the interaction of a smart card or other portable device (e.g., a mobile phone). Such a system would typically allow the holder to interact with various systems around the venue and to receive and benefit from communications, rewards and incentives for his use of the venue or loyalty to the venue operator. According to the Pinnick, et al. '655 published patent application, the venue can be a sports and entertainment venue, a shopping mall, a campus environment, or an airport. An interaction may be physical (such as enabling access via an access control application), financial (such as enabling a payment transaction to occur), promotional (such as enabling the card holder to benefit from a coupon or discount notice), or other interaction.

However, although the Pinnick, et al. '655 published patent application discloses a venue management system that provides a loyalty benefit scheme for sports and other spectator venues based on a member's loyalty points stored in the member's smart card and also discloses real time data capture, the Pinnick, et al. '655 published patent application does not appear to expressly disclose real-time electronic participation in the loyalty benefit scheme by retail establishments and businesses located outside the venue.

Other means for controlling venue access are known in the art, such as disclosed in U.S. Pat. No. 4,086,475 to Churchill; U.S. Pat. No. 5,287,269 to Dorrough, et al.; and U.S. Pat. No. 5,502,806 to Mahoney, et al.

Based on the discussion hereinabove, a venue attendee may be able to use a conventional smart card for venue access. However, use of a conventional smart card does not allow rewards to be issued to and used by the venue attendee in real-time while the venue attendee makes purchases at venue concession booths during the event or makes purchases at local retail businesses subsequent to the venue event.

It is instructive to define the terminology “smart card” as that terminology is customarily defined in the art. In this regard, the terminology “smart card” is customarily defined in the art to mean a card that contains a re-writable, integrated circuit (IC) micro-chip embedded in or on the card. The IC functions as a mini-computer and can hold significantly more data than the magnetic strip on a conventional debit card or credit card. Also, a smart card can process data by means of separate software programs stored on the smart card, as well as store the data. The software programs can execute simultaneously. Thus, the smart card can store card-holder identification, multiple bank account information, as well as perform data storage, software application execution and processing, and other functions. Therefore, a smart card can function either as cash, a debit card, or a credit card, as desired. Moreover, the smart card can be a contact-type smart card that physically engages a compatible card reader or a contactless-type smart card that communicates with a compatible card reader by means of radio frequency identification (RFID) capability.

Although the approaches recited hereinabove disclose various attempts for controlling venue access and incentive rewards, the approaches recited hereinabove do not appear to disclose the invention described and claimed hereinbelow.

### BRIEF SUMMARY OF THE INVENTION

The present invention addresses the shortcomings of the prior art attempts mentioned hereinabove by providing a smart card system and method for managing venue access in a time-saving manner and for automatically managing venue attendee rewards in real-time, the rewards being offered by venue concession booths located within the venue and by retail businesses located outside the venue. In this regard, the smart card system and method allows rewards, such as discounts and loyalty points, to be redeemed in real-time at venue concession booths during the event and at local retail businesses subsequent to the event. For example, the smart card system and method allows a venue attendee to use discounts and loyalty points in real-time for purchasing items at a concession booth at the event and then subsequently use other discounts and loyalty points in real-time to patronize a local restaurant following the event.

More specifically, the smart card system and method uses a smart card to manage access to a venue, such as a sports stadium venue, a concert hall venue, a theater venue, an amusement park venue, university sports venue, college sports venue, high school sports venue, or other venue. The smart card system and method also allows convenient, real-time updating of card holder data embedded in the smart card and that is also stored on a central server. The smart card system and method includes a rewards feature used in combination with the smart card to provide rewards (e.g., discounts, redeemable loyalty points) in real-time to individuals having authorized access to the venue by means of the smart card. The discounts and redeemable loyalty points are offered to venue attendees in order to encourage the venue attendees to patronize the concession booths at an event and to encourage venue attendees to patronize local retail businesses subsequent to the event. The rewards may be preloaded, loaded in real-time, and/or updated in real-time. In addition, a smart card production arrangement belonging to the smart card system and method can be beneficially used to mark the smart card with images, such as logos, and also used to initially embed or encode the smart card with updatable personalized data regarding the smart card holder.

The smart card system and method shortens the time required to process payment transactions at the venue. Shortening the time needed to process payment transactions at the venue leads to a faster-moving queue. The faster-moving queue allows the venue attendee to enter the venue quickly and thereby makes the event experience more enjoyable for the venue attendee. This is so because the venue attendee need only have his personalized, stored-value smart card read by a compatible smart card reader device located at the entrance to the venue. The smart card reader device is connected to a network that accepts payment from the smart card in real-time and allows the smart card holder to quickly enter the venue.

The smart card system and method can eliminate the need for a ticket booth attendant and a ticket taker. In this manner, use of the smart card system and method reduces labor costs and, therefore, is cost-efficient for the event promoter, venue owner and/or venue operator.

The smart card system and method can also eliminate possibility of counterfeit paper tickets that would otherwise be sold to unsuspecting, prospective venue attendees. This is so because paper tickets can be eliminated.

According to an aspect of the present invention, there is provided a smart card system for managing venue access and venue attendee rewards, comprising: a server; a venue access card reader coupled to the server; and a rewards database coupled to the server.

According to another aspect of the present invention, there is provided a smart card system for managing venue access and venue attendee rewards, comprising: a sever for storing and authenticating card holder account data associated with a card holder account; a venue access card reader coupled to the server for reading the card holder account data from a smart card and for transmitting the card holder account data read from the smart card to the server to authenticate the card holder account data, whereby card holder access to a venue is granted or optionally denied while the server authenticates the card holder account data; and a rewards database coupled to the server for granting a reward to the card holder account.

According to yet another aspect of the present invention, there is provided a smart card system for managing venue access and venue attendee rewards, comprising: a server; a venue access card reader coupled to the server for reading card holder account data from a smart card; a rewards database coupled to the server for providing rewards to the card-holder account in real-time; a concession card reader coupled to the server for reading the card holder account data from the smart card and for transmitting the card holder account data to the server, so that the server updates the card holder account data to yield updated card holder account data resulting from a commercial transaction occurring at a venue concession; a computer device coupled to the server for transmitting the card holder account data therebetween, the computer device being disposed remotely from the server; and a smart card production arrangement coupled to the server, the smart card production arrangement being adapted to acquire card holder account data from the server and encode the card holder account data into the smart card.

According to still another aspect of the present invention, there is provided a method of assembling a smart card system for venue access and venue attendee rewards, comprising the steps of: providing a server; coupling a venue access card reader to the server; and coupling a rewards database to the server.

A feature of the present invention is the provision of a venue access card reader coupled to a server for reading card holder account data from a smart card and for transmitting the card holder account data read from the smart card to the server in order to authenticate the card holder account data, card holder access to a venue being granted or optionally denied while the server authenticates the card holder account data.

Another feature of the present invention is the provision of a venue access gateway (e.g., turnstile) coupled to the venue access card reader for allowing or denying entrance into the venue in response to a signal received from the venue access card reader.

An additional feature of the present invention is the provision of a rewards database coupled to the server for granting rewards to a card holder account.

A further feature of the present invention is the provision of a smart card production arrangement coupled to the server, the smart card production arrangement being adapted to acquire card holder account data from the server and encode the card holder account data into the smart card.

Yet another feature of the present invention is the provision of a combination contact and contactless venue access card reader for reading either a contact or contactless smart card.

Still another feature of the present invention is the provision of a method of assembling a smart card system for venue access and venue attendee rewards.

In addition to the foregoing, various other method and/or device aspects and features are set forth and described in the teachings, such as text (e.g., claims and/or detailed description) and/or drawings of the present invention.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE SEVERAL VIEWS OF THE DRAWINGS

The invention will be more fully understood by reference to the detailed description in conjunction with the following figures, wherein:

FIG. 1 is a schematic showing an embodiment of a smart card system for managing venue access and venue attendee rewards, the smart card system including a remote computer device remotely communicating with a central server having card holder data stored therein, the smart card system also including a venue access smart card reader coupled to a gateway;

FIG. 2 is a view in perspective of a desktop remote computer device for remotely communicating with the central server having card holder data stored therein;

FIG. 3 is a view in perspective of a laptop remote computer device for remotely communicating with the central server having the card holder data stored therein;

FIG. 4 is a view in perspective of a notebook remote computer device for remotely communicating with the central server having the card holder data stored therein;

FIG. 5 is a view in perspective of a smart phone remote computer device for remotely communicating with the central server having the card holder data stored therein;

FIG. 6 is a schematic showing another embodiment of the smart card system for managing venue access and venue attendee rewards, the smart card system including the venue access smart card reader coupled to the gateway, but lacking the remote computer device;

FIG. 6A is a schematic showing yet another embodiment of the smart card system for managing venue access and venue attendee rewards, the smart card system including the venue access card reader coupled to the gateway and also including a ticket booth and ticket taker;

FIG. 6B is a schematic showing still another embodiment of the smart card system for managing venue access and venue attendee rewards, the smart card system having the venue access smart card reader in the form of a hand-held payment device and having the venue access smart card reader and gateway eliminated;

FIG. 7 is a front view in elevation of a smart card, the smart card having a battery operated micro-circuit disposed thereon or embedded therein;

FIG. 8 is a front view in partial vertical section of the smart card, the smart card having the battery operated micro-circuit disposed thereon or embedded therein, this view also showing an antenna embedded in the smart card and connected to the battery-operated micro-circuit belonging to the smart card;

FIG. 9 is a front view in partial vertical section of the smart card, the smart card lacking the battery for operating the micro-circuit disposed thereon or embedded therein, this view also showing the antenna embedded in the smart card and connected to the micro-circuit belonging to the smart card;

FIG. 10 is a rear view in elevation of the smart card, the smart card having a single magnetic recording strip thereon;

FIG. 10A is a rear view in elevation of the smart card, the smart card having a plurality of magnetic recording strips thereon;

FIG. 10B is a perspective view in partial section of a venue access contact smart card reader in operative condition to receive and read a contact smart card;

FIG. 10C is a perspective view in partial section of a venue access contactless smart card reader in operative condition to read a contactless smart card;

FIG. 10D is a perspective view in partial section of a combination venue access contact and contactless smart card reader in operative condition to receive and read either a contact or contactless smart card;

FIG. 10-E is a perspective view in partial section of a combination venue access contact and contactless smart card reader in operative condition to receive and read either a contact or contactless smart card, the combination venue access contact and contactless smart card reader having a keypad for entering a personal identification number (PIN) and/or other information;

FIG. 11 is a view in perspective of a concession booth contact smart card reader connected to a register for making a purchase at a concession booth;

FIG. 12 is a view in perspective of a concession booth contactless smart card reader connected to a register for making a purchase at the concession booth;

FIG. 13 is a view in perspective of a combination concession booth contact and contactless smart card reader connected to a register for making a purchase at the concession booth;

FIG. 14 is a top plan view of a hand-held payment device in operative condition to read a smart card;

FIG. 15 is a schematic showing a smart card production arrangement belonging to the smart card system for printing (i.e., encoding) the smart card; and

FIG. 16 is a flowchart showing an illustrative method of assembling the smart card system.

### DETAILED DESCRIPTION OF THE INVENTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

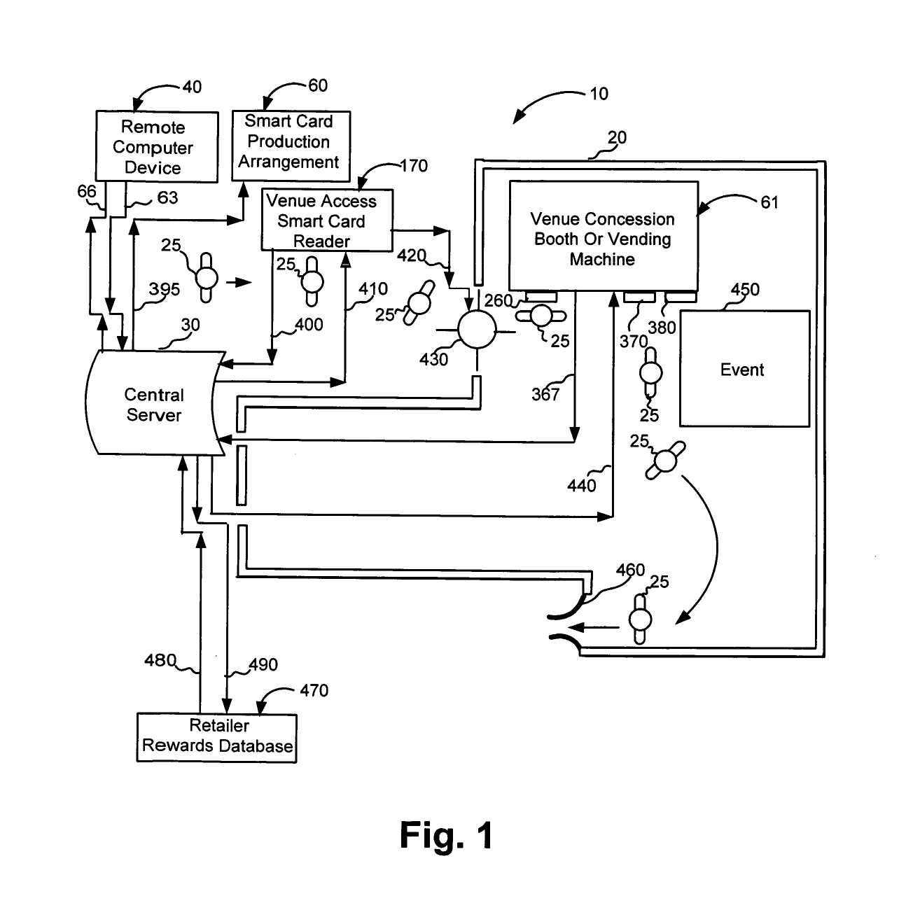

Therefore, with reference to FIG. 1, there is shown an embodiment of a smart card system, generally referred to as 10, for managing venue access and venue attendee rewards. A venue 20 to which access is sought by a prospective venue attendee 25 may be a sports stadium, concert hall, theater, amusement park, universities, colleges, high schools, or other venue.

Referring again to FIG. 1, smart card system 10 provides a substantial benefit to users of smart card system 10, such as venue attendee 25. In order to provide this substantial benefit, smart card system 10 comprises a central server 30 that is located within venue 20 or remotely from venue 20, such as anywhere in the United States or outside the United States. Central server 30 has a memory (not shown) therein capable of storing personal data relating to venue attendee 25. By way of example only, and not by way of limitation, the personal data relating to venue attendee 25 may be name, street address, state or province of residence, country, telephone number, age, marital status, hobbies, favorite sports teams, favorite foods, and other personal data and interests. As described in detail hereinbelow, the personal data and interests of venue attendee 25 are used to identify and authenticate venue attendee 25 and to target rewards to venue attendee 25 in real-time while venue attendee 25 uses smart card system 10.

Referring yet again to FIG. 1, central server 30 is capable of providing data services to public users, such as venue attendee 25, by means of the Internet (not shown) and may be a database server, file server, mail server, web server, application server, and/or other type of server capable of providing the data services. For enhanced performance and reliability, central server 30 includes a fast central processing unit (CPU), a high-performance random access memory (RAM), and enhanced reliability in the form of redundant power supplies, redundant memory storage, redundant network connections to the Internet, and server error detection and correction. The speed of the CPU, performance of RAM, number and capacity of power supplies, memory storage capacity, number of network connections, and type of error detection and correction required can be determined by a person of ordinary skill in the art of digital processing systems without undue experimentation and will depend on the number of users of central server 30 in addition to other factors.

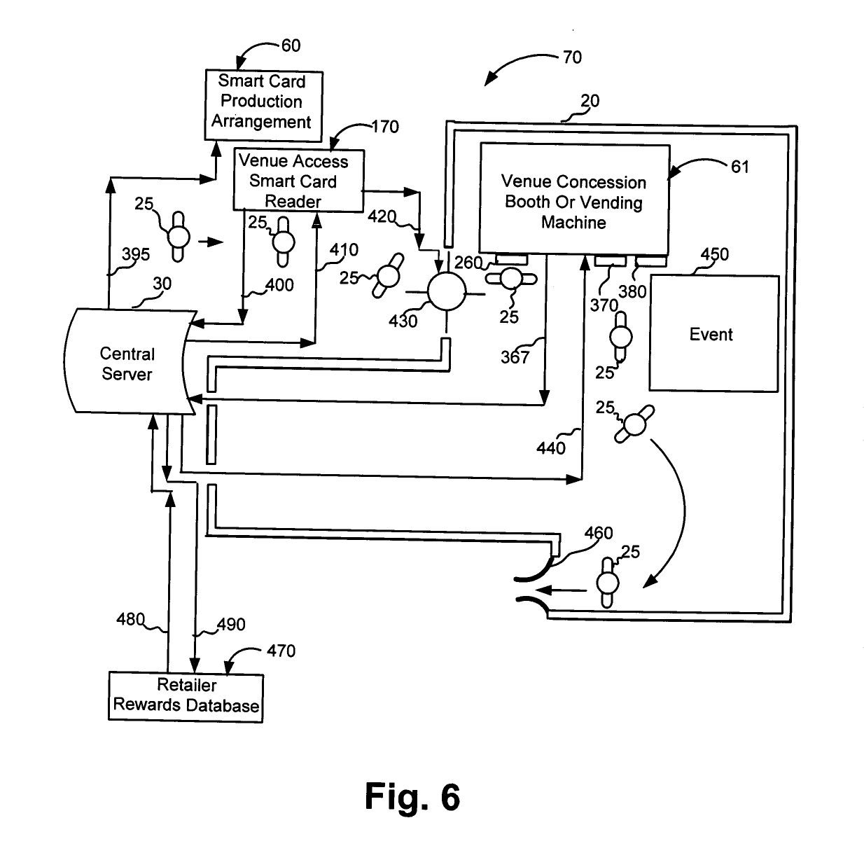

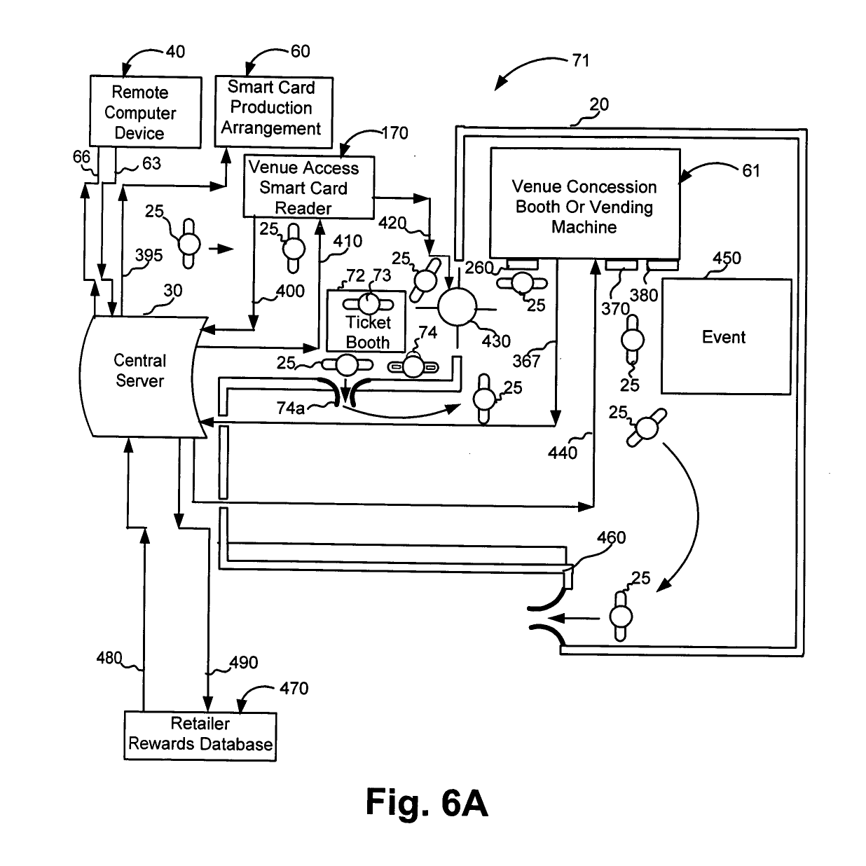

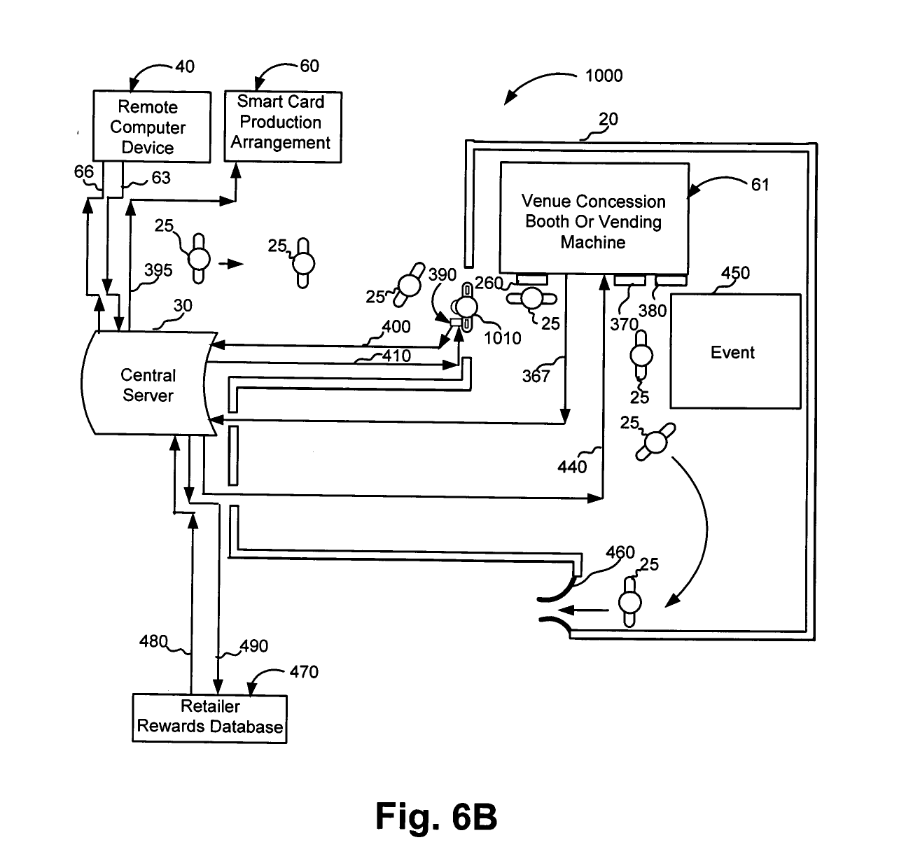

Referring to FIGS. 1, 2, 3, 4 and 5, smart card system 10 is adapted to allow a remote computer device, generally referred to as 40, to be in remote communication with central server 30, such as by means of the Internet, in order to allow venue attendee 25 to store his personal data and interests into the memory belonging to central server 30. Remote computer device 40 is selected from the group consisting essentially of a desktop computer 42, a laptop computer 44, a notebook computer 46, a smart phone 48 having computer software applications installed therein, and combinations thereof. In other words, it is contemplated that remote computer device 40 may be any suitable remote computer device capable of being remotely connected to server 30 by means of the Internet.

Referring again to FIGS. 1, 2, 3, 4 and 5, it is important that central server 30 includes appropriate security features to prevent unauthorized access to personal data files, software applications and the operating system contained within central server 30. In order to provide such security, the operating system is configured to authenticate a user, such as venue attendee 25, by requiring proof that the user is authorized to access central server 30. In order to achieve authentication, the operating system, any firmware, and applications (e.g., applications implementing network service) on central server 30 are configured to provide only secure access to central server 30. By way of example only, and not by way of limitation, such secure access can be provided by use of a login user identification (i.e., user ID) and password that is supplied by venue attendee 25 when venue attendee 25 accesses central server 30 by means of desktop computer 42, laptop computer 44, notebook computer 46, smart phone 48, and combinations thereof. The user ID and password for an authorized user granted access to central server 30 can be revoked by central server 30 or changed/updated at any time by the authorized user, such as venue attendee 25. Alternatively, by way of example only, and not by way of limitation, such secure access can be provided by hardware, including tokens (not shown) and one-time password devices (also not shown), to be used by venue attendee 25 for accessing central server 30. Central server 30 is also capable of at least temporarily denying access to any prospective user of central server 30 after a set number of unsuccessful login attempts. Various other known security features may be included in central server 30 to prevent unauthorized access to central server 30 and the personal data files, applications, operating system, and firmware disposed in central server 30.

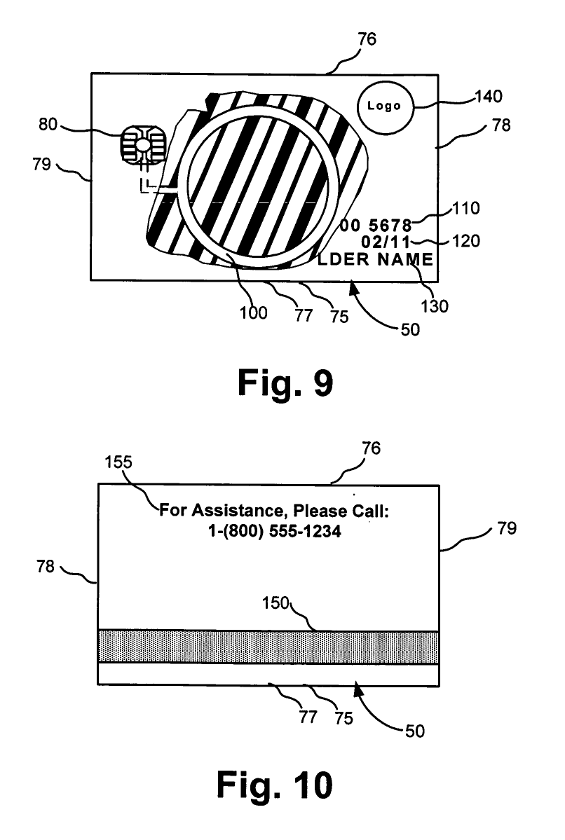

Referring yet again to FIGS. 1, 2, 3, 4 and 5, authorized access to central server 30 is initially obtained by prospective venue attendee 25 finding a website (not shown) that is located on the Internet and that is specifically identified with smart card system 10. The website is found on the Internet by prospective venue attendee 25 using any of a number of available Internet search engines. Prospective venue attendee 25 accesses the website using remote computer device 40, which can be any of the previously mentioned desktop computer 42, laptop computer 44, notebook computer 46, smart phone 48, and combinations thereof. When prospective venue attendee 25 finds and accesses the website on the Internet, prospective venue attendee 25 is queried as to whether he wishes to purchase a smart card, generally referred to as 50 (see FIGS. 7, 8, 9, 10 and 14), for obtaining access to one or more events occurring at a specified venue or a plurality of specified venues and for obtaining a plurality of venue attendee rewards. As described more fully hereinbelow, smart card 50 is a dual-purpose smart card in the sense that smart card 50 can be read by both radio frequency and magnetic means. The structure and functioning of smart card 50 and the manner in which smart card 50 is delivered to prospective venue attendee 25 are described in more detail hereinbelow. If the answer to this query (i.e., whether prospective venue attendee 25 desires to purchase smart card 50) is “yes”, prospective venue attendee 25 is then presented with a sign-up form (not shown) that requests the previously mentioned personal data and personal interest information pertaining to prospective venue attendee 25. The personal data and personal interest information is used by smart card system 10 to authenticate perspective venue attendee 25 when prospective venue attendee 25 later accesses control server 30 and to direct targeted rewards to venue attendee 25 in a manner disclosed in detail hereinbelow. If the answer to this query (i.e., whether prospective venue attendee 25 desires to purchase smart card 50) is “no”, prospective venue attendee 25 is prevented from proceeding with the sign-up process. If desired, paid advertisements from the owner/operator of venue 20 and from retail businesses can appear and persist on each webpage in order to enhance profitability of smart card system 10. After providing the requested personal data and personal interest information, prospective venue attendee 25 is provided with a list containing one or more possible venues, scheduled dates for events at each venue, and the admission price to attend each event. The price to attend each event includes a service fee for the privilege of using smart card system 10 and for the production and delivery of smart card 50, which can be mailed or otherwise delivered to prospective venue attendee 25. Prospective venue attendee 25 then proceeds to a check-out webpage that requests information associated with a credit card, debit card, an electronic check with appropriate bank routing number and bank account number information, or other payment means to allow prospective venue attendee 25 to pay for smart card 50.

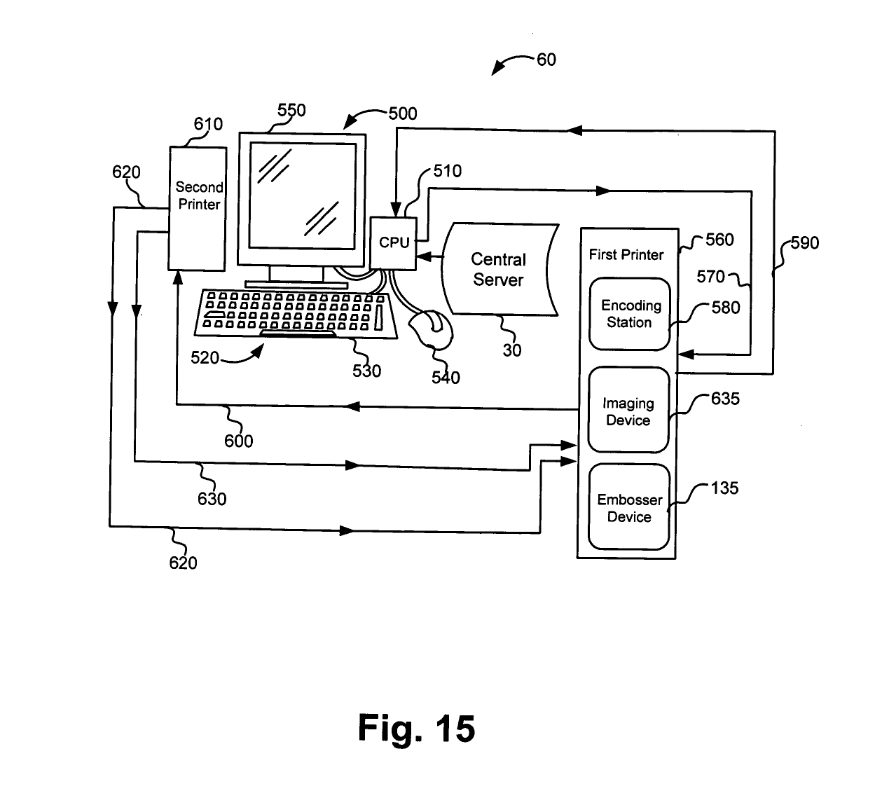

Still referring to FIGS. 1, 2, 3, 4 and 5, prospective venue attendee 25 is assigned an account in the memory located in central server 30. The account includes the personal data, personal interests, event selections, venue selections, and payment information entered by prospective venue attendee 25. The account also includes the account dollar balance initially available to prospective venue attendee 25 after prospective venue attendee 25 completes the sign-up and payment procedure. After payment by prospective venue attendee 25 is verified and accepted by central server 30, smart card 50 is encoded with the personal data, personal interests, and the available account dollar balance by means of a smart card production arrangement, generally referred to as 60 (see FIG. 15) and that is described in detail hereinbelow. Smart card 50 then can be mailed to prospective venue attendee 25 or otherwise delivered to prospective venue attendee 25, as previously mentioned.

It should be appreciated that smart card 50 can alternatively be a single-use smart card valid only for a specific event (e.g., a single football game) to occur at venue 20. In this case, venue attendee 25 will have to later purchase another smart card 50 for subsequent events he wishes to attend.

Referring again to FIGS. 1, 2, 3, 4 and 5, and as described more fully hereinbelow, the initial account dollar balance is debited and updated in the memory of central server 30 and in smart card 50 each time venue attendee 25 uses smart card 50 to pay an admission price to gain admission to venue 20. The initial account balance is also updated in the memory of central server 30 and in smart card 50 as venue attendee 25 makes purchases at a venue concession booth 61 or vending machine located within venue 20. Central server 30 also allows personal data, interests and account data of venue attendee 25 to be updated by venue attendee 25 at any time. For example, after sign-up, venue attendee 25 may increase his account balance by accessing the smart card system 10 webpage and replenishing the dollar amount available in his account by means of debit card, credit card, electronic check, or other payment means. The updating process is described more fully hereinbelow.

Still referring to FIGS. 1, 2, 3, 4 and 5, it should be appreciated by a person of ordinary skill in the art of digital processing systems that remote computer device 40 is capable of connecting to central server 30 by means of an outgoing signal 63 using the Internet, in order for venue attendee 25 to store his personal data, personal interests, and payment information into the memory on central server 30. Also, it should be appreciated by a person of ordinary skill in the art of digital processing systems that remote computer device 40 is capable of connecting to central server 30 by means of an incoming signal 66 using the Internet for receiving verification that the personal data, personal interests, and payment information of prospective venue attendee 25 were successfully received into the memory on central server 30. Incoming signal 66 is also used by central server 30 to notify prospective venue attendee 25 of any missing data required but not entered by prospective venue attendee 25 when prospective venue attendee 25 provided personal data, personal interests, and payment information in the sign-up form. In addition, if desired, incoming signal 66 can allow central server 30 to deposit one or more “cookies” onto remote computer device 40. A purpose of the cookies is to facilitate central server 30 authenticating venue attendee 25 whenever venue attendee 25 attempts to access central server 30 by means of remote computer device 40. As used herein, the terminology “cookie” is defined to mean a message given to a web browser by central server 30, the web browser being capable of executing operating instructions within remote computer device 40, when remote computer device 40 is connected to the Internet. The web browser, which is operated by prospective venue attendee 25, stores the message in a text file on remote computer device 40. The message is sent back to central server 30 each time the web browser requests a web page from central server 30. Thus, the cookie facilitates identifying prospective venue attendee 25 when prospective venue attendee connects to central server 30 and can assist prospective venue attendee 25 in completely and correctly providing requested personal data, personal interests, and payment information to central server 30.

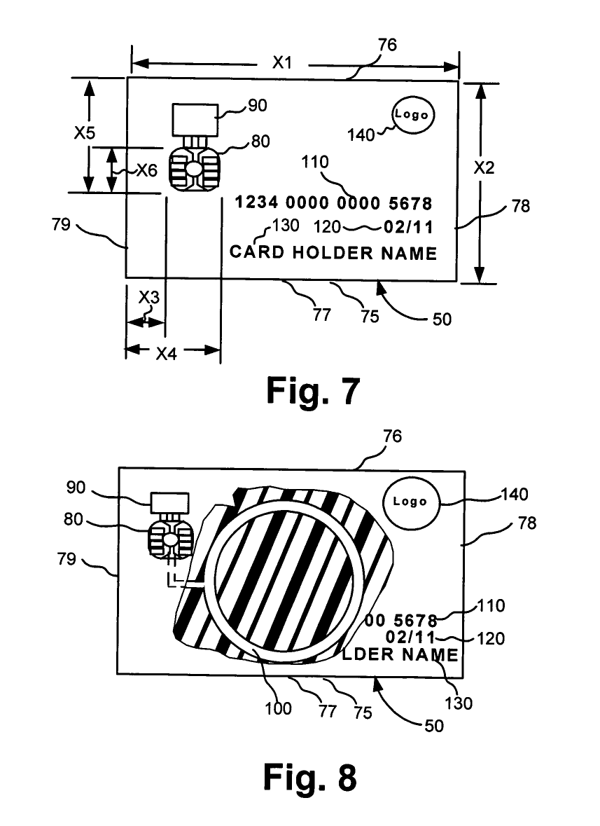

Turning now to FIG. 6, there is shown another alternative embodiment smart card system, generally referred to as 70, for managing venue access and venue attendee rewards. Alternative embodiment smart card system 70 is similar to smart card system 10, except remote computer device 40 is absent. In this case, prospective venue attendee 25 sends personal data, personal interest information, and payment information to the operator (not shown) of smart card system 70 by means of mail, facsimile or telephone. The operator of smart card system 70 then records the personal data, personal interest information, and payment information in the memory associated with central server 30. Recording the personal data, personal interest information, and payment information in the memory associated with central server 30 allows prospective venue attendee 25 to sign-up and use smart card system 70, even when prospective venue attendee 25 lacks direct access to central server 30. After sign-up, prospective venue attendee 25 can update his personal data, personal interest information, and payment information by telephone or written request (i.e., mail or facsimile) to the operator of smart card system 70. This alternative embodiment of the smart card system is particularly useful when venue attendee 25 lacks remote computer device 40 and/or access to the Internet.

In FIG. 6A, there is shown another alternative embodiment smart card system, generally referred to as 71, for managing venue access and venue attendee rewards. Alternative embodiment smart card system 71 is similar to smart card system 10, except a ticket booth 72 is provided for issuing a paper ticket (not shown) to venue attendee 25. A ticket booth attendant 73 is stationed in ticket booth 72 for completing a payment transaction with venue attendee 25 and thereafter issuing the paper ticket to venue attendee 25. The venue attendee 25 then presents the paper ticket to a ticket taker 74, who accepts the paper ticket and allows venue attendee 25 access to venue 20 through an entrance 74a. The payment transaction occurring at ticket booth 72 can be by means of cash, debit card, credit card, or personal check. Alternative embodiment smart card system 71 is particularly useful when venue attendee 25 forgot, misplaced or is otherwise not in possession of his smart card 50, when he arrives at venue 20. Alternative embodiment smart card system 71 is also particularly useful when venue attendee 25 has not purchased smart card 50. Thus, smart card system 71 allows venue attendee 25 access to venue 20 even when venue attendee 25 is not in procession of smart card 50. This embodiment may be less preferred than the other embodiments of the invention because this embodiment uses paper tickets that conceivably can be counterfeited. However, this embodiment nonetheless serves the useful purpose of allowing access to venue 20 when venue attendee 25 is not in possession of smart card 50.

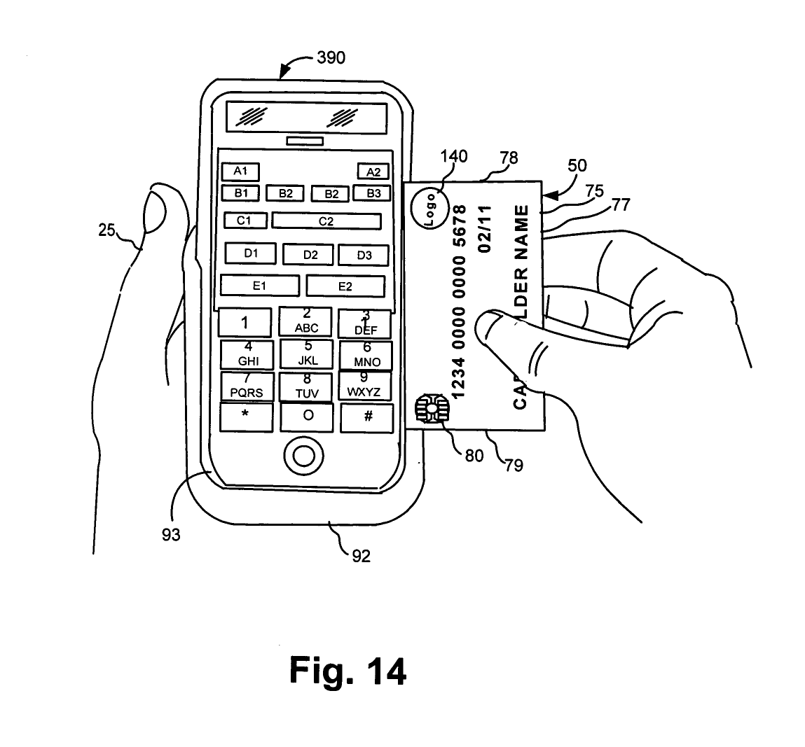

In FIG. 6B, there is shown yet another alternative embodiment smart card system, generally referred to as 1000, for managing venue access and venue attendee rewards. Alternative embodiment smart card system 1000 is similar to smart card system 10, except venue access smart card reader 170 and gateway 430 are eliminated. Rather, a gate attendant 1010 is provided to admit or deny admission to venue attendee 25. More specifically, gate attendant 1010 uses a battery operated hand-held payment device, generally referred to as 390 (see FIG. 14), that is capable of interacting with smart card 50 and central server 30 for accepting payment from venue attendee 25. Gate attendant 1010 grants venue attendee 25 access to venue 20 after central server 30, in cooperation with payment device 390, verifies and accepts payment by means of smart card 50.

The description hereinbelow will be primarily directed to the configuration and use of smart card system 10, it being understood that the description hereinbelow also applies to the alternative embodiments of smart card system 70, smart card system 71, and smart card system 1000.

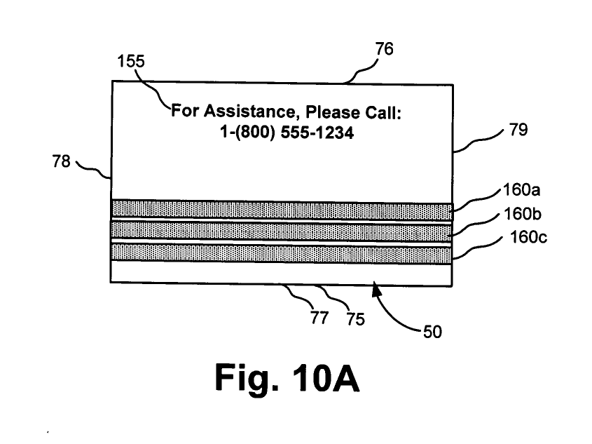

Referring to FIGS. 7 and 8, the structure of smart card 50 will now be described. In this regard, smart card 50 comprises a card body 75 made of a thermoplastic polymer material, such as polyvinyl chloride, polyethylene terephthalate, polyethylene terephthalate based polyesters, acrylonitrile butadiene styrene, polycarbonates, or other suitable polymer. Alternatively, card body 75 may be made of a metal, such as titanium, for enhanced durability. Card body 75 may be generally rectangular. In this regard, card body 75 has a first length-wise side edge 76 at the top of card body 75 and an opposite second length-wise side edge 77 at the bottom of card body 75, both side edges 76/77 being of length X1. Card body 75 also has a first width-wise side edge 78 at the right-hand side of card body 75 and an opposite second width-wise side edge 79 at the left-hand side of card body 75, both side edges 78/79 being of length X2. Disposed on or embedded within card body 75 is a re-writable, integrated circuit micro-chip or micro-circuit 80 that functions as a mini-computer and as data storage. Micro-circuit 80 can process data by means of separate software programs stored in micro-circuit 80, as well as store the data generated thereby. The software programs can execute simultaneously. Thus, smart card 50 can contain personal data to identify venue attendee 25, multiple bank account information, authorization for venue access, data storage, and can perform software application execution and processing and other functions.

Referring again to FIGS. 7 and 8, micro-circuit 80, which may be generally rectangular, has one side edge spaced apart from second width-wise side edge 79 by a distance X3. Micro-circuit 80 also has another opposite side edge spaced-apart from second width-wise side edge 79 by a distance X4. Although micro-circuit 80 is disclosed as generally rectangular, it should be appreciated that micro-circuit 80 may have any suitable size and shape for fitting micro-circuit 80 on or in card body 75. Also, micro-circuit 80 has a bottom edge spaced apart from first length-wise side edge 76 by a distance X5. In addition, micro-circuit 80 has a distance X6 along at least one side edge thereof, as shown. Further, according to a configuration of smart card 50, connected to micro-circuit 80 is a relatively light-weight, bendable, thin and flat battery 90 for powering micro-circuit 80 in order to operate micro-circuit 80 in a manner described hereinbelow. Battery 90 can supply sufficient power to a transmitter circuit (not shown) located in micro-circuit 80, such that micro-circuit 80 can interact with a suitable reader device by means of a radio frequency field, when smart card 50 is brought to within about five centimeters (i.e., about two inches) of the reader device. In this regard, battery 90 may be a rechargeable lithium polymer battery having a thickness of about 0.5 millimeters (0.019685 inches) to about 2.5 millimeters (0.098425 inches) for suitably fitting battery 90 on or in relatively thin card body 75. Such a battery 90 suitable for this purpose can be of a type that may be available from PowerStream Technology, Incorporated located in Orem, Utah U.S.A. However, battery 90 need not be present in card body 75. Rather, micro-circuit 80 may be powered by a radio frequency field transmitted from the card reader, as described more fully hereinbelow. Moreover, micro-circuit 80 is connected to an antenna 100 for reasons provided hereinbelow. Antenna 100 is disposed on or within card body 75. Moreover, smart card 50 is a dual-purpose smart card in the sense that smart card 50 can be read by radio-frequency or magnetic means for reasons disclosed hereinbelow.

Referring yet again to FIGS. 7 and 8, various indicia can be placed on the front side of card body 75, such as an account number 110 and account expiration month and year 120. Alternatively, the time period during which authorized use of smart card 50 can occur can be flexible and can be customized to meet the specific needs of venue attendee 25. In other words, the time interval during which use of smart card 50 is authorized can be set by smart card system 10 based on when venue attendee plans to use smart card 50. This time period can be set to correspond to the calendar dates of events selected by venue attendee 25 during initial sign-up. For example, the time period can be set to correspond to the 17-week length of the football season in the United States. More specifically, the National Football League regular season begins the weekend after Labor Day (i.e., the first Monday in September) and ends in December or early January. Thus, in this example, venue attendee 25 would only be allowed access to venue 20, which would be a football stadium, during that 17-week calendar time period.

Referring once again to FIGS. 7 and 8, if desired, the name 130 of venue attendee 25 can optionally be provided on card body 75. Account number 110, account expiration month and year 120, and name 130 of venue attendee 25 can be embossed on the front side of card body 75 by a suitable embosser device 135 that is a component of smart card production arrangement 60 (see FIG. 15). In addition, an image 140, such as in the form of a logo, can be provided on card body 75 by smart card production arrangement 60. Image 140 may be provided on card body 75 by means of an inkjet printer (not shown), laser printer (also not shown), or other suitable imaging device. Image 140 can be formed over the entire front surface of card body 75 or only over a portion of the front surface of card body 75. Image 140 can be any desired image, such as a sports association trademark (e.g., “NFL” for the National Football League), a trademark associated with the supplier of smart card 50, a trademark associated with the owner or operator of venue 20, a customized image supplied by venue attendee 25, or other image.

Still referring to FIGS. 7 and 8, It should be understood that the previously mentioned dimensions X1 through X6 can have any suitable values that allow smart card 50, which may be about 0.70 mm (0.030 in) thick, to be conveniently carried in pocket, wallet or purse. By way of example only, and not by way of limitation, the following TABLE presents exemplary values for dimensions X1 through X6.

TABLE
Exemplary Values for Dimensions X1 Through X6

| Dimension | Description | Value (millimeters) | Value (inches) |
|---|---|---|---|
| X1 | Lengths of first | 85.598 | 3.37 |
| | length-wise side | | |
| | edge and second | | |
| | length-wise side | | |
| | edge | | |
| X2 | Lengths of first width- | 53.975 | 2.125 |
| | wise side edge and | | |
| | second width-wise | | |
| | side edge | | |
| X3 | Distance between a | 8.6360 | 0.34 |
| | side edge of micro- | | |
| | circuit and second | | |
| | width-wise side edge | | |
| X4 | Distance between | 21.590 | 0.85 |
| | another side edge of | | |
| | micro-circuit and | | |
| | second width-wise | | |
| | side edge. | | |
| X5 | Distance between | 29.718 | 1.17 |
| | bottom edge of | | |
| | micro-circuit and first | | |
| | length-wise side | | |
| | edge | | |
| X6 | Distance of at least | 18.034 | 0.71 |
| | one side edge of | | |
| | micro-circuit | | |

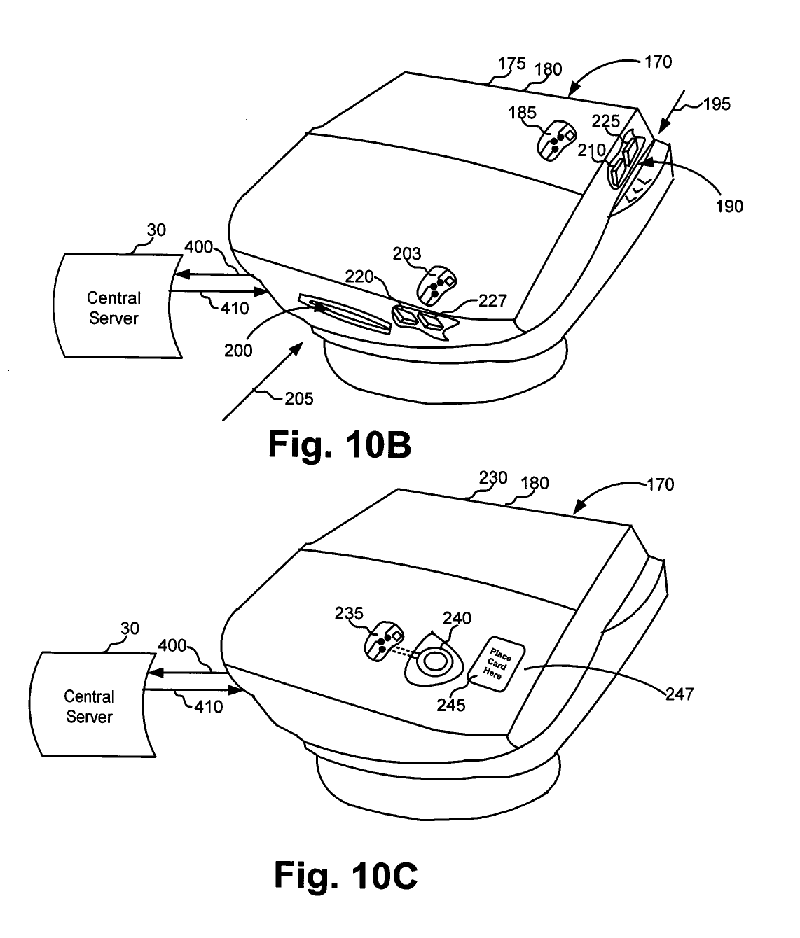

Referring to FIG. 9, there is shown another configuration of smart card 50. According to this configuration of smart card 50, battery 90 need not be present, as previously mentioned. In this case, battery 90 is not used to power micro-circuit 80. Rather, micro-circuit 80 is powered by a radio frequency field transmitted by the card reader, the radio frequency field being received by antenna 100. By way of example only, and not by way of limitation, the frequency of the radio frequency field can be about 13.56 megahertz (MHz) with a range of about five centimeters (i.e., two inches). Thus, in order to retrieve data stored in micro-circuit 80, smart card 50 having micro-circuit 80 disposed thereon or embedded therein should be brought within about five centimeters (i.e., two inches) of the source of the radio frequency field for a few seconds. When smart card 50 is placed within the radio frequency field, micro-circuit 80 absorbs and stores the energy from the radio frequency field. The stored energy is converted to direct current electricity for powering micro-circuit 80. The micro-circuit 80 then sends data associated with venue attendee 25 to antenna 100. The antenna 100 thereafter transmits the data by means of a radio frequency signal to the card reader device. In a manner disclosed hereinbelow, the data is then transmitted from the card reader device to central server 30 for authentication. Thus, the card reader device facilities authentication of the data (e.g., account number) received by the card reader device. A card reader device suitable for this purpose is disclosed hereinbelow.

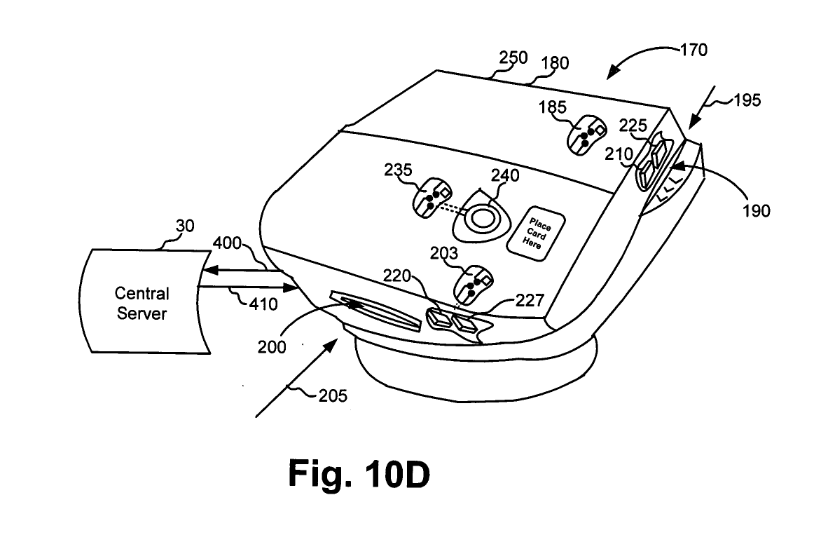

With reference to FIG. 10, a rear side of card body 75 is there shown. The rear side of card body 75 can include an optional single magnetic recording strip 150 thereon capable of storing the previously mentioned personal account data and interests of venue attendee 25. Magnetic recording strip 150 can be applied to the rear side of card body 75 by means of smart card production arrangement 60 (see FIG. 15) while smart card 50 is being encoded. The rear side of card body 75 may also include contact information 155, such as a telephone number, for venue attendee 25 to seek technical support in case smart card 50 does not operate as expected or otherwise malfunctions. The personal account data and interests of venue attendee 25 that are stored in magnetic recording strip 150 can be updated in real-time while venue attendee 25 pays for admittance into venue 20 and/or pays for items purchased while inside venue 20. The manner in which personal account data and interests are updated in magnetic recording strip 150 is described in more detail hereinbelow. Thus, smart card 50 is a dual-purpose smart card in the sense that the data on smart card 50 can be read by radio-frequency and magnetic means. This dual functionally of smart card 50 allows smart card 50 to be read by a magnetic card reader when a radio frequency card reader is unavailable or to be read by a radio frequency card reader when a magnetic card reader is unavailable.

As shown in FIG. 10A, there can be a plurality of optional, dedicated magnetic recording strips 160a, 160b and 160c for respectively storing data, such as personal account data, interests information, venue selection information, and other information relating to venue attendee 25. For example, magnetic recording strip 160a can be dedicated to storing data regarding the venues and events selected and paid for by venue attendee 25. Magnetic recording strip 160b can be dedicated to storing financial data regarding an account balance and banking information associated with the account assigned by server 30 to venue attendee 25. Magnetic recording strip 160c can be dedicated to storing other data associated with venue attendee 25, such as rewards available to and used by venue attendee 25. Data stored in magnetic recording strips 160a/160b/160c can be updated as venue attendee uses smart card 50. Although three of the plurality of magnetic recording strips 160a/160b/160c are shown, it should be understood that more or fewer than the three magnetic recording strips may be disposed on the rear side of card body 75 depending on the amount and type of data stored. The plurality of magnetic recording strips 160a/160b/160c can increase data storage capacity on smart card 50 as compared to the storage capacity of single magnetic recording strip 150. Also, presence of the dedicated plurality of magnetic recording strips 160a/160b/160c can increase security of data contained on smart card 50. In this regard, presence of the dedicated plurality of magnetic recording strips 160a/160b/160c can permit access to only one of the plurality of magnetic recording strips 160a/160b/160c depending on the type of transaction occurring. For example, access only to the venue admission and payment data in magnetic recording strips 160a and 160b is allowed when venue attendee 25 is merely seeking admittance into venue 20. As another example, access only to the account payment data in magnetic recording strip 160b and the rewards data in magnetic recording strip 160c is allowed when venue attendee 25 makes a purchase at concession booth 61 or a vending machine (see FIG. 1).

Referring again to FIGS. 7, 8, 9, 10 and 10A, it should be appreciated that the terminology “front”, “rear”, “top”, “bottom”, “right-hand side”, “left-hand side” and similar terminology are used herein for convenience only and are not intended to be in any way limiting because venue attendee 25 may hold smart card 50 in any position and at any desired angle or orientation.

As best seen in FIGS. 1 and 10B, there is shown a venue access smart card reader, generally referred to as 170, in operative condition to read the personal account data stored in micro-circuit 80 and/or stored on the optional single magnetic recording strip 150 or the plurality of optional magnetic recording strips 160a/160b/160c disposed on smart card 50. Venue access smart card, reader 170, which may be disposed on gateway 430, controls whether to admit venue attendee 25 into venue 20 or to deny admittance. More specifically, venue access smart card reader 170 may be a contact smart card reader 175 comprising a housing 180 in which is disposed a first electronic circuit 185 for reading data from smart card 50 when smart card 50 physically engages contact smart card reader 175. In this regard, a first slot 190, which is in communication with electronic circuit 185, is formed in housing 180 for slidably receiving smart card 50 generally along the direction identified by directional arrow 195. A second slot 200, which is in communication with a second electronic circuit 203, is formed in housing 180 for inserting smart card 50 generally along the direction identified by directional arrow 205. Second slot 200 provides an alternative means for smart card 50 to engage housing 180, in order to accommodate the preference of venue attendee 25 as to the manner in which he desires that smart card 50 engage contact smart card reader 175.

Referring again to FIGS. 1 and 10B, first electronic circuit 185 and second electronic circuit 203 comprise a first contact pad 210 and a second contact pad 220, respectively. First electronic circuit 185 is adapted to cooperate with first contact pad 210 when first contact pad 210 contacts micro-circuit 80 in order to power micro-circuit 80 that is disposed on or in smart card 50. Similarly, second electronic circuit 203 is adapted to cooperate with second contact pad 220 when second contact pad 220 contacts micro-circuit 80 in order to power micro-circuit 80 that is disposed on or in smart card 50. In order to power and read data from micro-circuit 80, the micro-circuit 80 includes contact plates (not shown) that are used to communicate with contact card reader 175 by means of direct electrical contact with contact pads 210/220. When smart card 50 physically engages contact smart card reader 175, contact pads 210/220 in contact smart card reader 175 sit on the contact plates included in micro-circuit 80. When micro-circuit 80 is powered, micro-circuit 80 transmits account data to contact smart card reader 175. Contact smart card reader 175 also comprises a first magnetic strip reading head 225 and a second magnetic strip reading head 227 for reading previously mentioned single magnetic recording strip 150 or the plurality of magnetic recording strips 160a/160b/160c of the smart card 50. Thus, when smart card 50 slidably engages first slot 195 or is inserted into second slot 200, contact smart card reader 175 will read data from micro-circuit 80 or optional single magnetic recording stripe 150 or the plurality of optional magnetic recording stripes 160a/160b/160c. In this manner, smart card 50 is a dual-purpose smart card in the sense that smart card 50 allows reading of data either from micro-circuit 80 or magnetic recording strips 150/160a/160b/160c.

Referring yet again to FIGS. 1 and 10B, after smart card 50 physically engages smart card reader 175, the contact smart card reader 175 sends the account data to central server 30 in a manner disclosed hereinbelow. In this manner, and as previously mentioned, smart card 50 contacts and engages contact smart card reader 175 for reading the personal account data of venue attendee 25, which personal account data is stored in micro-circuit 80 or on magnetic recording strips 150/160a/160b/160c. Thus, contact smart card reader 175 can read data from micro-circuit 80 or from optional magnetic recording strips 150/160a/160b/160c. This dual functionality of contact smart card reader 175 is particularly useful if micro-circuit 80 is blank or data therein corrupted for any reason or if data on magnetic recording strips 150/160a/160b/160c is missing or corrupted due to damage to magnetic recording strips 150/160a/160b/160c. Such damage to magnetic recording strips 150/160a/160b/160c might be caused by mishandling of smart card 50.

Still referring to FIGS. 1 and 10B, contact smart card reader 175 in combination with smart card 50 allows venue attendee 25 to quickly gain access to venue 20, if the personal account data is validated by central sever 30. Venue attendee 25 quickly gains access to venue 20 merely by swiping smart card 50 in the direction of directional arrow 195 or inserting smart card 50 in the direction of directional arrow 205. Thus, venue attendee 25 need not wait in a long queue that first must approach a ticket booth to purchase a paper ticket and then present the paper ticket to a ticket taker before gaining access to venue 20. In a manner disclosed hereinbelow contactless smart card reader 230 is also capable of facilitating updating of the personal account data stored in smart card 50 in order to reflect the purchase that allows venue attendee 25 access to venue 20.

Referring to FIGS. 1 and 10C, there is shown another configuration of venue access smart card reader 170 in operative condition to interact with and read the personal account data residing in micro-circuit 80 that is disposed in or on smart card 50. In this configuration of venue access smart card reader 170, smart card 50 need not physically engage venue access smart card reader 170. Therefore, in this configuration, smart card reader 170 has no ability to read magnetic recording strips 150/160a/160b/160c. Thus, this configuration of venue access smart card reader 170 is a contactless smart card reader 230. Contactless smart card reader 230 comprises previously mentioned housing 180 in which is disposed an electronic circuit 235 capable of reading the personal account data of venue attendee 25 by means of an antenna 240 emitting a radio frequency field or signal (not shown) that interacts with antenna 100 that is embedded in smart card 50 (see FIG. 8) and that is coupled to micro-circuit 80. In order to properly receive the radio frequency signal, venue attendee 25 need only place smart card 50 within approximately five centimeters (i.e., approximately two inches) of antenna 240, so that the personal account data in micro-circuit 80 can be read. In order for venue attendee 25 to place smart card 50 within an optimal distance (i.e., five centimeters or two inches) from antenna 240, a location area 245 is identified on an exterior surface 247 of contactless smart card reader 230. Antenna 240 that is disposed in contactless smart card reader 230, emits the radio frequency signal that is received by antenna 100, which is disposed on or in smart card 50. Antenna 100, which is coupled to micro-circuit 80, then powers micro-circuit 80. By means of antenna 100 in smart card 50, micro-circuit 80 then returns a signal to antenna 240 that is disposed in contactless smart card reader 230. The signal returned to antenna 240 contains the personal account data residing in micro-circuit 80. Contactless smart card reader 230 sends the personal account data to central server 30 in a manner disclosed hereinbelow. This feature of contactless smart card reader 280 allows venue attendee 25 to quickly gain access to venue 20, if the personal account data is validated by central server 30. Venue attendee 25 quickly gains access to venue 20 merely by placing smart card 50 sufficiently near contactless smart card reader 230, such as at location area 245.

With reference to FIGS. 1 and 10D, venue access card reader 170 may be a combination contact and contactless smart card reader 250. In this regard, combination contact and contactless smart card reader 250 comprises previously mentioned first electronic circuit 185, first contact pad 210 and first magnetic strip reading head 225 for reading smart card 50 while smart card 50 slidably engages first slot 190 that is formed in combination contact and contactless smart card reader 250. In addition, combination contact and contactless smart card reader 250 comprises previously mentioned second electronic circuit 203, second contact pad 220 and second magnetic strip reading head 227 for reading smart card 50 while smart card 50 is inserted into second slot 200 formed in combination contact and contactless smart card reader 250. Moreover, combination contact and contactless smart card reader 250 further comprises previously mentioned electronic circuit 235 and antenna 240 for reading smart card 50 while smart card 50 is brought sufficiently near combination contact and contactless smart card reader 250. Thus, combination contact and contactless smart card reader 250 provides enhanced versatility for reading data from smart card 50 because combination contact and contactless smart card reader 250 can read either a contact or contactless smart card. This configuration of venue access smart card reader 170 is particularly useful for accommodating the two expected types (i.e., contact and contactless) of smart cards that might be issued to venue attendees for gaining admission to venue 20.

FIG. 10E shows another combination contact and contactless smart card reader, generally referred to as 255, for gaining access to venue 20. The combination contact and contactless smart card reader 255 is similar to combination contact and contactless smart card reader 250, except an alphanumeric keypad 257 and a recessed liquid crystal display (LCD) viewing screen 258 are provided. Keypad 257 facilitates entering a personal identification number (PIN) and/or identifying information in order to obtain secure access to the personal account data residing on central server 30. Viewing screen 258 shows information for enabling venue attendee 25 to correctly enter his personal identification number and/or other identifying information.

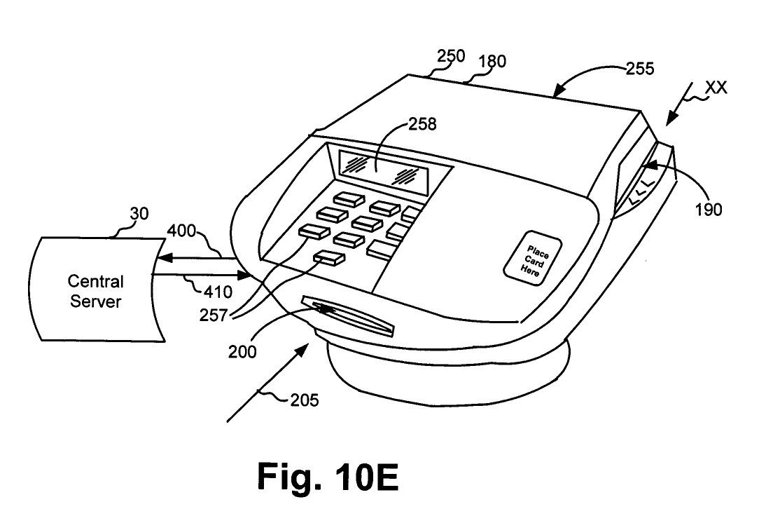

Referring to FIGS. 1 and 11, there is shown a contact point of sale (POS) smart card reader, generally referred to as 260, which may be disposed at previously mentioned concession booth 61 or installed in a suitable vending machine. Point of sale contact smart card reader 260 comprises an enclosure 270 having a first slit 280 and a second slit 290 therein. First slit 280 is sized to slidably receive smart card 50 therealong generally in the direction of directional arrow 295. Second slit 290 is sized to receive smart card 50 thereinto generally in the direction of directional arrow 297. One or more electronic circuits (not shown) are disposed in enclosure 270 in communication with slits 280/290 for reading data from smart card 50 while smart card 50 engages either of slits 280/290.

Referring again to FIGS. 1 and 11, in order to facilitate completing a transaction for purchase of goods and services offered at concession booth 61 where point of sale contact smart card reader 260 is located and in order to update personal account data of venue attendee 25 stored in smart card 50 and central server 30, a plurality of alphanumeric input keys 300 are provided on a surface 310 of enclosure 270. Alphanumeric input keys 300 are in communication with the electronic circuits disposed in enclosure 270, such that the electronic circuits are responsive to the manipulation of alphanumeric input keys 300 by venue attendee 25. A display screen 320, which may be a liquid crystal display (LCD) screen, provides visual feedback to venue attendee 25 as venue attendee 25 manipulates alphanumeric input keys 300. Therefore, alphanumeric input keys 300 are used to enter the user ID and/or password associated with the personal account data of venue attendee 25. However, for security reasons, at no time are the user ID, password, and/or personal identification number (PIN) associated with the personal account data of venue attendee shown on display screen 220. In addition, a transaction cancellation key 330, a scroll key 340 for scrolling through information shown on display screen 320, and an enter key 350 for completing a series of keystroke instructions are also provided on point of sale contact smart card reader 260 for facilitating use of point of sale contact smart card reader 260 by venue attendee 25.

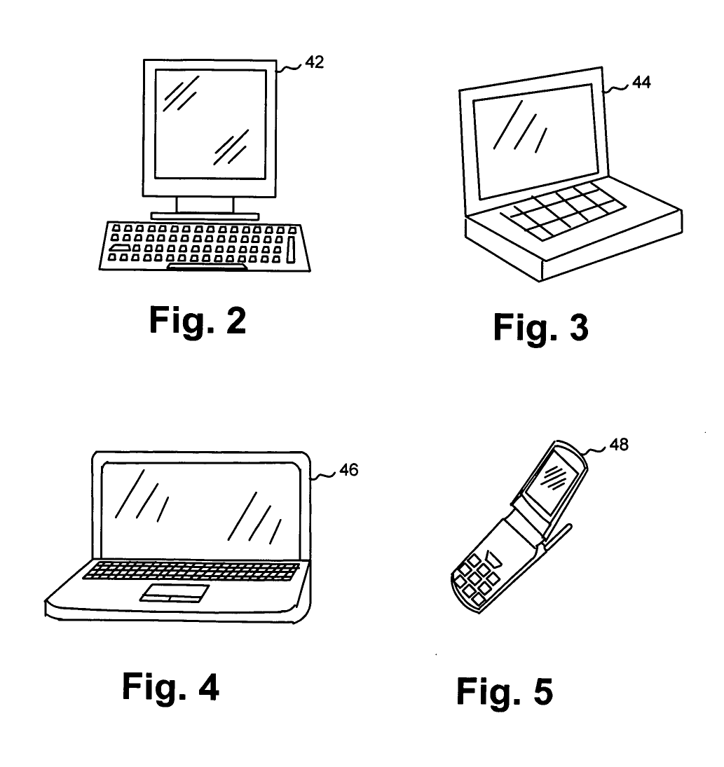

As seen in FIG. 11, a register 360 is electrically connected, such as by an electrical cable 365, to point of sale contact smart card reader 260 for powering point of sale contact smart card reader 260 and for transmitting transaction information therebetween. Register 360, which is located at concession booth 61 (see FIG. 1), transmits transaction information to point of sale contact smart card reader 260 as well as receives transaction information from point of sale contact smart card reader 260. For example, transaction information transmitted from register 360 to point of sale contact smart card reader 260 might be type and price of merchandise or service purchased at concession booth 61. Transaction information transmitted from point of sale contact smart card reader 260 to register 360 might be confirmation of the purchase, user ID, password, and/or user PIN. Transaction information transmitted to register 360 is then relayed to central server 30 by means of an outgoing transaction payment signal 367 that passes through the Internet. For security purposes, the transmission of outgoing transaction payment signal 367 may be encrypted. Central server 30 then validates or denies the purchase transaction depending on the current status of the personal account data stored in central server 30 for venue attendee 25. If confirmed and validated, central server 30 returns a validation signal 368 approving the purchase and updates the personal account data stored in central server 30 to reflect the amount of the purchase and the type of merchandise or service purchased. Central server 30 stores the updated personal account data for real-time access by venue attendee 25. However, if the payment transaction is not confirmed or validated, central server 30 returns a validation signal 368 disapproving the purchase. For example, the purchase may be disapproved if there is an insufficient account balance to make the purchase or if the personal identification number (PIN) was entered incorrectly by venue attendee 25, or if the personal account for venue attendee 25 was deactivated or canceled for any reason. A report providing information regarding purchases is made available to venue attendee 25 online and in real-time by venue attendee 25 accessing central server 30. In other words, venue attendee 25 can access his updated personal account data that is stored on central server 30 at any time using any of the previously mentioned computer devices 42/44/46/48 (see FIGS. 2-5). Alternatively, such a report can be automatically mailed or faxed to venue attendee 25 at periodic intervals.

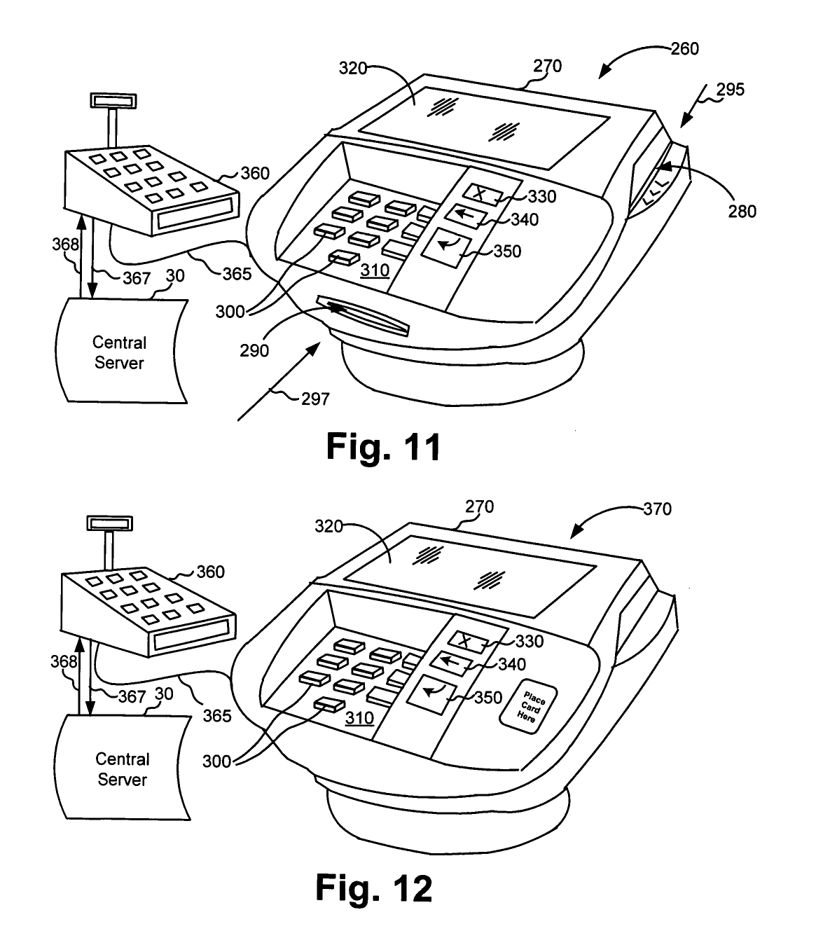

As best seen in FIG. 12, there is shown a contactless point of sale (POS) smart card reader, generally referred to as 370. Contactless point of sale smart card reader 370 operates similarly to contact point of sale smart card reader 260, except a radio frequency field is used to communicate personal account data to and from smart card 50 and contactless point of sale smart card reader 370 without smart card 50 physically engaging contactless point of sale smart card reader 370. In order to achieve this result, both contactless point of sale smart card reader 370 and smart card 50 have antenna disposed therein for transmitting and receiving transaction information therebetween by means of the radio frequency field.

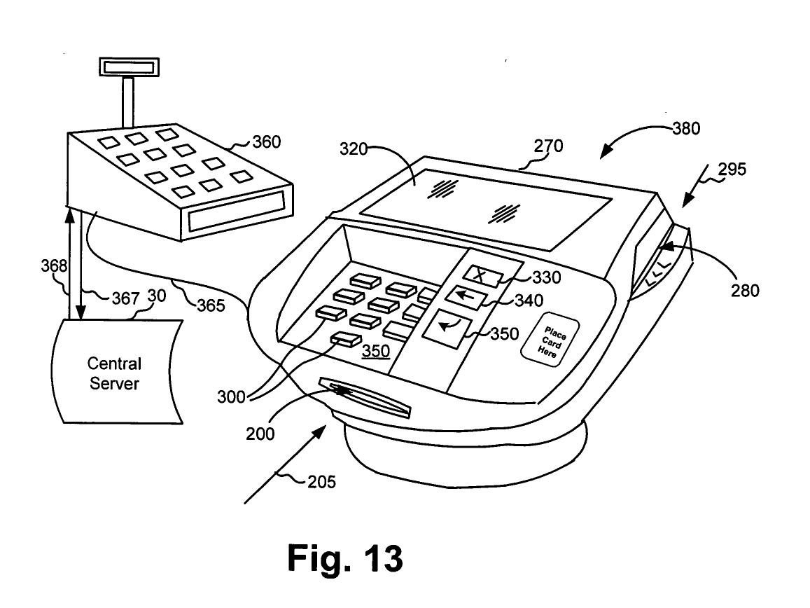

As best seen in FIG. 13, there is shown a combination contact and contactless point of sale (POS) smart card reader, generally referred to as 380. Combination point of sale smart card reader 380 operates similarly to contact and contactless point of sale smart card readers 260/370. Thus, combination point of sale (POS) smart card reader 380 is adapted to read both contact and contactless smart cards. This feature of combination point of sale smart card reader 380 is particularly useful in order to accommodate either contact or contactless types of smart cards 50 that might be issued to venue attendees 25.

Referring to FIG. 14, previously mentioned battery operated hand-held payment device 390 is shown interacting with smart card 50 for allowing smart card 50 to access personal account data stored in central server 30 and for transmitting the personal account data, such as available account balance information, to smart card 50. Interaction between payment device 390 and smart card 50 is by means of contact or contactless capability. Thus, payment device 390 is capable of reading either a contact or contactless smart card. In other words, payment device 390 is capable of reading smart cards 50 having magnetic strips 150/160a/160b/160c and/or micro-circuit 80. Payment device 390 is available at venue 20 for use by venue attendee 20 or for use by gateway attendant 1010.

Referring again to FIG. 14, payment device 390 includes a cradle 92 defining a recess 93 therein for receiving payment device 390. Cradle 92 facilitates holding and stabilizing the position of payment device 390 as payment device 390 is used to read smart card 50. Smart card system 1000 (see FIG. 6B) allows venue attendee 25 or gate attendant 1010 to use payment device 390 for accessing central server 30 by means of the Internet in order to determine if there is a sufficient account balance to pay the price of admission to venue 20. If there is a sufficient account balance, then payment device 390 debits the account in the amount of the admission price, so that venue attendee 25 may gain access to venue 20. Venue attendee 25 can replenish the available account balance stored in smart card 50 in order to pay for access to venue 20. A payment device 390 suitable for this purpose may be a VeriFone™ “VX 680™” payment device available from Verifone, Incorporated located in San Jose, Calif. U.S.A. The Verifone™ VX 680™ payment device is a full-function and portable payment device that includes optional integrated contactless capability, and a large, color touch screen, all on a proprietary software platform.

Returning to FIGS. 1, 6, 6A and 6B, the manner in which venue attendee 25 uses smart card systems 10/70/71/1000 to gain access into venue 20, make purchases therein and receive available loyalty rewards and incentives will now be described.

Therefore, referring to FIGS. 1 and 6, venue attendee 25 accesses central server 30 by means of a web browser (not shown) installed on remote computer 40. An outgoing signal 63 from remote computer device 40 is directed to a website (not shown) that is associated with central server 30 on the Internet. Remote computer device 40 can be desktop computer 42, laptop computer 44, notebook computer 46, cell phone 48, or other remote computer device. The website presents a sign-up form (not shown) that requests identifying information, including personal interests, regarding venue attendee 25. In addition, the sign-up form requests venue attendee to select events he wants to attend and corresponding venues he wants to access. The sign-up form also requests payment for smart card 50, which payment is made by credit card, debit card, electronic check or other payment means. The identification and personal interest information from remote computer device 40 are stored on central server 30 and also transmitted back to venue attendee 25 at remote computer device 40 for verification. The identification and personal interest information are transmitted back to venue attendee 25 by means of incoming signal 66. Once verified, the identification and personal interest information are used to establish a personal data account that is stored on central server 30. The personal data account established on central server 30 is transmitted to smart card production arrangement 60 by a personal data transmission signal 395 for encoding and producing smart card 50 in the manner disclosed hereinbelow. After smart card 50 is encoded and produced, smart card 50 is delivered to venue attendee 25 by conventional mail or other means. It should be appreciated that smart card 50 can alternatively be a single-use smart card valid only for a specific event (e.g., a single football game) to occur at venue 20. In this case, venue attendee 25 will have to purchase another smart card 50 for each subsequent event or plurality of subsequent events he wishes to attend.

Referring again to FIGS. 1 and 6, in order to gain access to a selected event to occur in venue 20, venue attendee 25 presents smart card 50 to previously mentioned venue access smart card reader 170, which reads the personal account data from smart card 50. Venue access smart card reader 170 then transmits the personal account data to central server 30 by means of an outgoing verification signal 400 for verifying personal account data read from smart card 50. Result of the verification process is transmitted back to venue access smart card reader 170 by an incoming verification signal 410 from central server 30. If central server 30 fails to verify personal account data read from smart card 50, then access to venue 20 is denied. However, if central server 30 verifies the personal account data, then access to venue 20 is granted. As previously mentioned, the admission fee is paid by venue attendee 25 when venue attendee 25 purchased smart card 50 during the sign-up process or when venue attendee 25 later updates his personal data account by replenishing the account balance in his personal data account. During verification, the amount of the admission fee is debited against the dollar balance existing in the personal account on central server 30 and a portion of the admission fee is thereafter remitted to the promoter of the event and/or the owner or operator of venue 20. In this respect, a portion of the admission fee is retained by the operator of smart card systems 10/70/71/1000 as compensation for allowing use of smart card systems 10/70/71/1000 by the promoter of the event and/or by the owner or operator of venue 20. The portion of the admission fee that is retained is in addition to a fixed price venue attendee 25 paid the operator of smart card systems 10/70/71/1000 in order to obtain smart card 50. This encourages venue attendee 25 to select a plurality of events to attend because the fixed price paid to obtain smart card 50 is spread over the plurality of events. Thus, revenue received by the operator of smart card systems 10/70/71/100 comes from two sources. One source of revenue is venue attendee 25 when venue attendee 25 purchases smart card 50 at the fixed price. The other source of revenue is the promoter of the event and/or the owner or operator of venue 20 when a portion of the admission price otherwise payable to the promoter of the event and/or the owner or operator of venue 20 is retained by the operator of smart card systems 10/70/71/100 as compensation for allowing the promoter of the event and/or the operator/owner of venue 20 to use smart card systems 10/70/71/1000.

Referring yet again to FIGS. 1 and 6, after successful verification of the account for venue attendee 25, a “gate open” signal 420 is transmitted to a gateway, which may be a turnstile 430, or other entrance structure. Gate open signal 420 opens turnstile 430, so that venue attendee can enter venue 20.

Referring to FIG. 6A, and as previously mentioned, smart card system 71 provides means for accommodating venue attendee 25 if venue attendee 25 forgot, misplaced or is otherwise not in possession of smart card 50 when he arrives at venue 20 and seeks access. This would also occur if venue attendee 25 chose not to purchase smart card 50 during the sign-up process. However, denying access to venue attendee 25 because venue attendee lacks smart card 50 would disappoint venue attendee 25 and reduce revenue for the promoter of event 450 and the owner and/or operator of venue 20. Therefore, smart card system 71 allows venue attendee 25 to purchase a paper ticket at ticket booth 72 and present the paper ticket to ticket taker 74, who then grants venue attendee 25 access to venue 20, as mentioned hereinabove.

Referring to FIG. 6B, as an alternative embodiment, turnstile 430 may be eliminated. Rather, an attendant, such as gate attendant 1010, may be stationed at the entrance to venue 20 for either allowing or denying access to venue 20. In this regard, gate attendant 1010 uses previously mentioned payment device 390 for reading smart card 50 in order to accept payment from venue attendee 25, so that venue attendee 25 may access venue 20.

Referring to FIGS. 1, 6, 6A and 6B, once inside venue 20, venue attendee 25 might visit concession booth 61 for purchasing an item, such as food, event related merchandise (e.g., baseball caps with sports team insignia thereon), or other offered items, by means of smart card readers 260, 370 or 380. Previously mentioned outgoing transaction payment signal 367 is transmitted from register 360 (see FIGS. 11, 12 and 13) to central server 30 for verification that the personal account for venue attendee 25 is active and that there is a sufficient balance in the personal account of venue attendee 25 to pay for the purchase. Central server 30 responds to this query from register 360 by transmitting an incoming transaction payment signal 440 to register 360 that either approves the purchase or declines to approve the purchase. In either case of approval or disapproval, venue attendee 25 proceeds to an event 450. As previously mentioned, event 450 may be a sports contest, concert, movie, theme park attraction, or other event. Alternatively, venue attendee 25 may choose not to visit concession booth 61 to make a purchase. Thus, making a purchase at concession booth 61 before proceeding to event 450 is optional. After attending event 450, venue attendee 25 leaves venue 20 through an exit 460.

Still referring to FIGS. 1, 6, 6A and 6B, and as previously mentioned, smart card systems 10/70/71/1000 allow rewards to be granted to venue attendee 25. For example, rewards granted to venue attendee 25 may be based on the number of times venue attendee 25 patronized venue 20 in the past using smart card 50. To facilitate granting of rewards, a retailer's rewards database 470 transmits an outgoing rewards signal 480 to central server 30. Outgoing rewards signal 480 contains data pertaining to incentives and discounts on goods and/or services offered by a retailer, such as a local restaurant, sports apparel and equipment store, car rental agency, hotel, motel, airline, car dealership, or other retailer. The data carried by outgoing rewards signal 480 is stored on central server 30 and allocated to the plurality of venue attendee accounts based on the interests expressed by each venue attendee when the venue attendee initially signed-up for his smart card 50 or when the venue attendee subsequently updated his interests. For example, if venue attendee 25 expressed an interest in certain foods, the reward might be a discount on meals that can be purchased at a local restaurant. As another example, if venue attendee 25 expressed an interest in golf, the reward might be a discount on purchases at a retail business selling golf equipment and/or golf apparel. Data in retailer rewards database 470 can be updated at any time by the retailer and transmitted to central server 30 in order to update the rewards information stored in central server 30. Rewards stored and granted to venue attendee 25 are available for use by venue attendee 25 whenever venue attendee uses smart card 50 to make a payment at venue access card reader 170, at payment device 390, or makes a purchase at concession booth 61. In addition, an incoming rewards signal 490 is transmitted from central server 30 to retailer rewards database 470 for tracking the number and types of rewards used by venue attendees.

, Referring again to FIGS. 1, 6, 6A and 6B, rewards also may be granted by concession booth 61 to incentivize venue attendee 25 to patronize concession booth 61. In this regard, outgoing transaction payment signal 367 to central server 30 can contain rewards information that will be assigned to personal data accounts of the plurality of venue attendees who selected to attend an event at venue 20 where concession booth 61 is located. Central server 30 then assigns the rewards to account holders who expressed a personal interest (e.g., “alcoholic beverages”) corresponding to items (e.g., beer) that are sold at concession booth 61. Venue attendee 25 would have expressed this personal interest during the previously mentioned sign-up process to purchase smart card 50 or during subsequent updates to his personal interests. Incoming transaction payment signal 440 can then contain the reward to be granted venue attendee 25, such as a discount on a purchase being made at concession booth 61, while venue attendee 25 is in the process of making a purchase at concession booth 61. In other words, smart card systems 10/70/71/1000 can apply the reward (e.g., discount) in real-time while venue attendee 25 is making the purchase at concession booth 61.

The manner in which previously mentioned smart card production arrangement 60 encodes and produces smart card 50 will now be described.

Turning now to FIG. 15, previously mentioned smart card production arrangement 60 is provided for encoding a smart card blank (not shown) with the personal account data and interests of prospective venue attendee 25. Encoding the smart card blank with the personal account data and interests of prospective venue attendee 25 occurs after the payment transaction made by prospective venue attendee 25 during the previously mentioned sign-up process is verified and accepted by central server 30.

Referring again to FIG. 15, smart card production arrangement 60 comprises a process control unit, generally referred to as 500, for controlling the smart card production process. More specifically, after prospective venue attendee 25 successfully completes the previously described sign-up process to obtain smart card 50, central server 30 transmits personal account data regarding venue attendee 25 to a central processing unit (CPU) 510 that belongs to process control unit 500. Coupled to CPU 510 is an input device, generally referred to as 520, that may include a keyboard 530 for inputting control instructions and a “mouse” pointer 540 for selecting process control operations. Input device 520 also includes a display monitor 550 for displaying the process control instructions, the mouse pointer movements, and the progress of process control operations. An operator (not shown) of process control unit 500 instructs CPU 510, by means of input device 520, to send the personal account data of prospective venue attendee 25 to a first printer 560. The personal account data is sent to first printer 560 by means of a first print signal 570. First printer 560 places the blank smart card in position for printing (i.e., encoding) at an encoding station 580 disposed within first printer 560 for encoding the blank smart card with the personal account data of venue attendee 25.

Referring again to FIG. 15, after the blank smart card is in position for printing within first printer 560, the first printer 560 sends a card-in-position signal 590 to CPU 510 that causes display monitor 550 to display confirmation that the blank smart card is in position for printing. After first printer 560 sends the card-in-position signal to CPU 510, first printer 560 also sends a print command signal 600 to a second printer 610 for producing a preview paper printout for viewing by the operator of smart card production arrangement 60 in order to verify information to be printed on the blank smart card, and for continuing the printing process after the information is verified. Second printer 610 allows the operator of smart card production arrangement 60 to verify accuracy of the personal account data for venue attendee 25, Second printer 510 sends the verified personal account data to first printer 560 by means of a verification data signal 620. Second printer 610 also sends a “continue printing” signal 630 to first printer 560 to enable first printer 560 to print (i.e., encode) micro-circuit 80, which is disposed on or embedded in the smart card blank, with the verified personal account data of venue attendee 25. The “continue printing” signal 630 sent to first printer 560 can also enable first printer 560 to print (i.e., encoded) optional magnetic recording strips 150/160a/160b/160c, which may be present on the smart card blank.

Referring yet again to FIG. 15, first printer 560 also includes an imaging device 635 adapted to apply images to the blank smart card, such as sport team logos, custom images supplied by venue attendee 25, images supplied by the operator or owner of venue 20, or other images. Such logos and images can be applied to the smart card blank by means of an inkjet imaging device (not shown), laser imaging device (also not shown), or other suitable imaging device associated with first printer 560. Also, such images can be holographic images, if desired. In addition, indicia can be embossed on the blank smart card, such as previously mentioned account number 110, expiration date 120, and name 130 of venue attendee 25, if desired (see FIG. 7). Thereafter, the completed smart card 50 is mailed to venue attendee 25 or otherwise delivered to venue attendee 25.

### Illustrative Method:

An illustrative method associated with an exemplary embodiment for assembling the smart card system according to the invention will now be described.

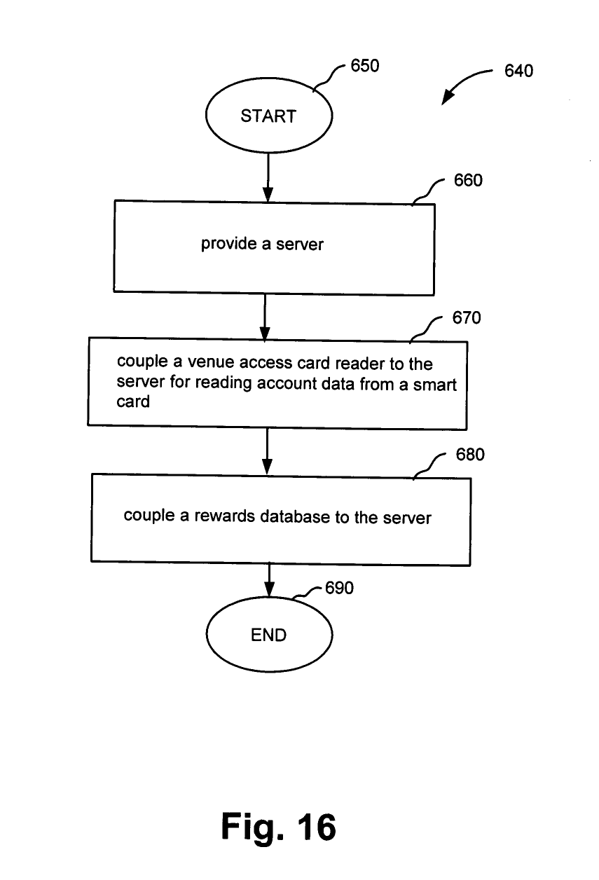

Therefore, referring to FIG. 16, an illustrative method, generally referred to as 640, is provided for assembling the smart card systems. The method starts at a step 650. At a step 660, a server is provided. At a step 670, a venue access card reader is coupled to the server. At a step 680, a rewards database is coupled to the server. The method stops at a step 690.

Other modifications and implementations will occur to those skilled in the art without departing from the spirit and the scope of the invention as claimed. For example, smart card 50 can be made from an impact-resistant polymer composite, such as a polyester resin impregnated with fiberglass reinforcing fibers, for increased durability and fracture resistance. Accordingly, the description hereinabove is not intended to limit the invention, except as indicated in the following claims.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. The patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicant(s).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Therefore, provided herein are a smart card system for managing venue access and venue attendee rewards, and a method of assembling the smart card system.

What is claimed is:

1. A smart card system for managing venue access and venue attendee rewards, comprising:
(a) a server;
(b) a venue access card reader coupled to said server; and
(c) a rewards database coupled to said server.

2. The system of claim 1, further comprising a concession card reader coupled to said server.

3. The system of claim 1, further comprising a venue access gateway coupled to said venue access card reader.

4. The system of claim 1, wherein said server is adapted to be coupled to a computer device disposed remotely from said server.

5. The system of claim 1, further comprising a smart card production arrangement coupled to said server.

6. A smart card system for managing, venue access and venue attendee rewards, comprising:
(a) a sever for storing and authenticating card holder account data associated with a card holder account;
(b) a venue access card reader coupled to said server for reading the card holder account data from a smart card and for transmitting the card holder account data read from the smart card to said server to authenticate the card holder account data, whereby card holder access to a venue is granted or optionally denied while said server authenticates the card holder account data; and
(c) a rewards database coupled to said server for granting a reward to the card holder account.

7. The system of claim 6, further comprising a venue access gateway coupled to said venue access card reader for managing access into the venue, said venue access card reader being operable to open said venue access gateway for granting admittance into the venue or optionally to close said venue access gateway for denying admittance into the venue.

8. The system of claim 6, wherein said venue access card reader is a contact venue access card reader.

9. The system of claim 6, wherein said venue access card reader is a contactless venue access card reader.

10. The system of claim 6, wherein said venue access card reader is a combination contact and contactless venue access card reader.

11. The system of claim 6, further comprising a concession card reader coupled to said server for reading the card holder account data from the smart card and for updating the card holder account data to yield updated card holder account data while conducting a commercial transaction at a venue concession, said concession card reader being adapted to transmit the updated card holder account data to said server.

12. The system of claim 11, wherein said concession card reader is a contact concession card reader.

13. The system of claim 11, wherein said concession card reader is a contactless concession card reader.

14. The system of claim 11, wherein said concession card reader is a combination contact and contactless concession card reader.

15. The system of claim 6, wherein said server is adapted to be coupled to a computer device for transmitting the card holder account data therebetween, the computer device being disposed remotely from said server.

16. The system of claim 6, wherein said server is adapted to be coupled to a computer device for transmitting the card holder account data therebetween, the computer device being selected from the group consisting essentially of a desktop computer, a laptop computer, a notebook computer, a smart phone, and combinations thereof.

17. The system of claim 6, further comprising a smart card production arrangement coupled to said server, said smart card production arrangement being adapted to acquire card holder account data from said server and encode the card holder account data into the smart card.

18. The system of claim 17, wherein said smart card production arrangement is adapted to encode the card holder account data into a micro-circuit disposed on or optionally within the smart card.

19. The system of claim 18, wherein said smart card production arrangement is adapted to encode the card holder account data onto a magnetic strip disposed on the smart card.

20. The system of claim 17, wherein said smart card production arrangement comprises an imaging device adapted to apply an image to the smart card.

21. A smart card system for managing venue access and venue attendee rewards, comprising:
(a) a server;
(b) a venue access card reader coupled to said server for reading card holder account data from a smart card;
(c) a rewards database coupled to said server for providing rewards to the card holder account data in real-time;
(d) a concession card reader coupled to said server for reading the card holder account data from the smart card and for transmitting the card holder account data to said server, so that said server updates the card holder account data to yield updated card holder account data resulting from a commercial transaction occurring at a venue concession;
(e) a computer device coupled to said server for transmitting the card holder account data therebetween, the computer device being disposed remotely from said server; and
(f) a smart card production arrangement coupled to said server, said smart card production arrangement being adapted to acquire card holder account data from said server and encode the card holder account data into the smart card.

22. The system of claim 21, wherein said venue access card reader is a contact venue access card reader.

23. The system of claim 21, wherein said venue access card reader is a contactless venue access card reader.

24. The system of claim 21, wherein said venue access card reader is a combination contact and contactless venue access card reader.

25. The system of claim 21, wherein said concession card reader is a contact concession card reader.

26. The system of claim 21, wherein said concession card reader is a contactless concession card reader.

27. The system of claim 21, wherein said concession card reader is a combination contact and contactless concession card reader.

28. The system of claim 21, further comprising a venue access gateway coupled to said venue access card reader.

29. The system of claim 21, wherein said computer device is selected from the group consisting essentially of a desktop computer, a laptop computer, a notebook computer, a smart phone, and combinations thereof.

30. The system of claim 21, wherein said smart card production arrangement is adapted to encode the card holder account data into a micro-circuit disposed on or optionally within the smart card for reading the card holder account data by a radio frequency field emitted by an antenna belonging to said venue access card reader or optionally by another antenna belonging to said concession card reader.

31. The system of claim 30, wherein said smart card production arrangement is adapted to encode the card holder account data onto a magnetic strip disposed on the smart card for reading the card holder account data by a magnetic recording head belonging to said venue access card reader or optionally belonging to said concession card reader.

32. The system of claim 21, wherein said smart card production arrangement comprises an imaging device adapted to apply an image to the smart card.

33. A method of assembling a smart card system for venue access and venue attendee rewards, comprising the steps of:
(a) providing a server;
(b) coupling a venue access card reader to the server; and
(c) coupling a rewards database to the server.

34. The method of claim 33, further comprising the step of coupling a concession card reader to the server.

35. The method of claim 33, further comprising the step of coupling a venue access gateway to the venue access card reader.

36. The method of claim 33, wherein the step of providing a server comprises the step of providing a server adapted to be coupled to a computer device disposed remotely from the server.

37. The method of claim 33, further comprising the step of coupling a smart card production arrangement to the server.
